(19) United States
(12) Patent Application Publication
(10) Pub. No.: US 2008/0224615 A1
(43) Pub. Date: Sep. 18, 2008

(54) Metal Halide Lamp and Lighting Device Using This

(76) Inventors: Masanori Higashi, Kyoto (JP); Takashi Maniwa, Osaka (JP); Rie Tonomori, Nara (JP)

Correspondence Address: SNELL & WILMER L.L.P. (Matsushita), 600 ANTON BOULEVARD, SUITE 1400, COSTA MESA, CA, 92626, US

(21) Appl. No.: 10/593,741

(22) PCT Filed: Mar. 31, 2005
(86) PCT No.: PCT/JP05/06250

§ 371 Date: Sep. 20, 2006

(30) Foreign Application Priority Data
Mar. 31, 2004 (JP) 2004-107782
Sep. 29, 2004 (JP) 2004-283893

(51) Int. Cl. H01J 61/04; H01J 61/18; H01J 61/30

(52) U.S. Cl. 313/631; 313/638; 313/634

(57) ABSTRACT

The arc tube 3 comprises: a translucent ceramic envelope 19 including a central tube 16 having an inner diameter of 5.5 mm or more, thin tubes 18 formed, on contact with joining portions 17, onto both ends of the central tube 16, and at least one rare earth halide enclosed therein; and electrode inductors 24 and 25 inserted and sealed in the thin tubes 18. In a cross section of the arc tube 3 along a plane including the axis X in the longitudinal direction, an angle α between the straight-line section of the inner surface of the central tube 16 and that of each joining portion 17 is set to 85°-115°. Clearance gaps 26 are formed between the thin tubes 18 and electrode inductors 24 and 25. The curvature radius of the inner surface of each boundary region 20 between the central tube 16 and joining portions 17 is set to 0.5 mm-2.5 mm.

### TECHNICAL FIELD

The present invention relates to a metal halide lamp, and a luminaire using the metal halide lamp.

### BACKGROUND ART

As shown in FIG. 26, a conventional metal halide lamp, such as a ceramic metal halide lamp for example, has an arc tube 59 including: a translucent ceramic envelope 56 that has a central tube 53 and thin tubes 55, each of the thin tubes 55 connected to a corresponding end of the central tube 53 via a joining portion 54; and electrode inductors 58 each having an electrode 57 formed at its tip end. Here, the electrode inductors 58 are respectively inserted into the thin tubes 55 and fixed so that the electrodes 57 are set in the space surrounded by the central tube 53 and joining portions 54. In the envelope 56, rare earth halides, such as scandium iodide, yttrium iodide, holmium iodide and thulium iodide, are enclosed as light-emitting material (see Patent Reference 1, for example).

When used as light-emitting material, these rare earth halides produce a continuous spectrum, which allows to attain a high color rendering. [Patent Reference 1] Japanese Laid-Open Patent Application Publication No. H6-196131

### DISCLOSURE OF THE INVENTION

### Problems that the Invention is to Solve

Ceramic metal halide lamps of this kind generally have a rated life of 9000 hours, however, in recent years, there is a demand for even longer operating life with the object of curbing the maintenance cost of luminaries and saving resources.

In response to such a demand, the present inventors addressed an issue of extending the operating life of the conventional ceramic metal halide lamp described above.

However, the inventors faced the following problems with the conventional ceramic metal halide lamp. That is, when the conventional ceramic metal halide lamp was lit, especially, in a vertical position (i.e. lit with the longitudinal axis of the lamp being vertical) for more than 9000 hours, cracks (indicated by CR in FIG. 26) formed within the thin tube 55 located at a lower position, close to the joining portion 54, at a lighting period of, for example, 10000 hours, and accordingly a leak occurred.

The cracks appeared prominently in the thin tube 55 at a lower position when the lamp was lit in the vertical position, while no cracks were identified in the thin tube 55 at an upper position. On the other hand, in the case when the lamp was lit in a horizontal position (i.e. lit with the longitudinal axis of the lamp being horizontal), cracks formed within neither of the two thin tubes 55 in some cases, while forming in both of the two thin tubes 55 in other cases.

Having been made in order to solve the above problems, the present invention aims at offering a metal halide lamp and a luminaire using the same, the metal halide lamp being capable of preventing crack formation, especially at a part within each thin tube, located close to the joining portion, and a subsequent leak over a long lighting period to thereby achieve extension of the operating life.

### Means to Solve the Problems

With an examination of the cause of the crack formation, the present inventors found the following: (1) ceramic which is a constituent material of the envelope 56 was deposited on the inner surface of the thin tube 55, where cracks formed, and deposit 60 was in contact with the electrode inductor 58; and (2) on the inner surface of the thin tube 55, an area in the vicinity of where ceramic was deposited, located on the side away from the joining portion 54, was stripped to form a gouge. A reference numeral 61 in FIG. 26 indicates the gouged area on the inner surface of the thin tube 55.

Based on these facts, the inventors considered the cause of the crack formation as follows.

That is, surplus of the enclosed metal halides, in particular rare earth halides, entered a clearance gap 62 between the thin tube 55 and the electrode inductor 58 while the lamp was lit, and reacted with ceramic forming the envelope 56. As a result of the reaction, the inner surface of the thin tube 55 was partially stripped to form the gouged area 61. Subsequently, the gouged ceramic was gradually deposited at the same spot (located in the vicinity of the gouged area 61, on the side closer to the joining portion 54) on the inner surface of the thin tube 55, and the deposited ceramic eventually came in contact with the electrode inductor 58. Then, in the wake of the repetition of the lamp being lit on and off, substantial stress was exerted on the thin tube 55 due to a difference in thermal expansion coefficients between the deposit 60 and the electrode inductor 58 at the point of contact. Thus, the stress induced cracks in the thin tube 55.

Note that the above description is concerned with a phenomenon that occurred in the thin tube 55 at a lower position when the lamp was lit in the vertical position, or a phenomenon that occurred in both thin tubes 55 in which cracks formed in the case when the lamp was lit in the horizontal position. However, in the case when the lamp was lit in the vertical position, there were also cases in which the inner surface of the upper thin tube 55 was slightly stripped, although cracks did not form therein.

The inventors have found the following means for solving the above-cited problems after conducting various examinations based on such newly obtained knowledge. That is to say, the metal halide lamp of the present invention comprises an arc tube that includes: a translucent ceramic envelop having a central tube having an inner diameter of 5.5 mm or more and two thin tubes respectively connected to each end of the central tube via joining portions, and enclosing therein at least a rare earth halide; and electrode inductors, each of which (1) has an electrode formed at a tip end thereof, (2) is inserted into one of the thin tubes with a clearance gap provided between the electrode inductor and the thin tube so that the electrode is disposed in a space surrounded by the central tube and the joining portions, and (3) is sealed in the thin tube at an end thereof opposite a central tube side. Here, in the cross section of the envelope along a plane including the axis in a longitudinal direction of the arc tube, an angle α formed by each straight-line section of the inner surface of the central tube and a straight-line section of the inner surface of a respective one of the joining portions is in the range of 85° to 115°. In addition, a curvature radius of the inner surface of each boundary region between the central tube and the joining portions is in the range of 0.5 mm to 2.5 mm.

In addition, the metal halide lamp of the present invention comprises an arc tube that includes a translucent ceramic envelop including a central tube having an inner diameter of 5.5 mm or more and two thin tubes respectively positioned on each end of the central tube via joining portions, and enclosing therein at least a rare earth halide; and electrode inductors, each of which (1) has an electrode formed at a tip end thereof, (2) is inserted into one of the thin tubes with a (clearance) gap left therebetween provided between the electrode inductor and the thin tube so that the electrode is disposed in a space surrounded by the central tube and the joining portions, and (3) is sealed in the thin tube at an end thereof opposite a central tube side. Here, in the cross section of the envelope along a plane including the axis in a longitudinal direction of the arc tube, an angle α formed by each straight-line section of the inner surface of the central tube and a straight-line section of the inner surface of a respective one of the joining portions is in the range of 85° to 115°. In addition, a taper section is formed on an inner surface of each boundary region between the central tube and the joining portions, and in the cross section, a length of line segment AC and a length of line segment BC are respectively in the range of 0.5 mm to 2.5 mm when a boundary point between the inner surface of the central tube and the taper section is a point A, a boundary point between the inner surface of the respective one of the joining portions and the taper section is a point B, and an intersecting point of a straight line extending from the straight-line section of the inner surface of the central tube with a line extending perpendicularly from the point B toward the straight line is a point C.

Here, an alkaline earth metal halide may be enclosed in the envelope. Here, when a projection length of the electrode is E (mm) and a minimum wall thickness of each boundary region between the joining portions and the thin tubes is t_{b} (mm), each value for the projection length E and the minimum wall thickness t_{b} is found within the area defined by lines connecting four points of (E, t_{b})=(0.5, 1.0), (0.5, 3.5), (5.0, 3.5), and (5.0, 0.5).

Furthermore, the inventors have found that the following means also achieves extension of the operating life of a metal halide lamp. That is to say, the metal halide lamp of the present invention comprises an arc tube including an envelope which is a translucent ceramic tube having a main tube in a center thereof and a pair of thin tubes on each side of the main tube. Here, a light emitting material is enclosed in the envelope. The light emitting material contains at least one rare earth metal halide selected from the group consisting of thulium (Tm), holmium (Ho) and dysprosium (Dy) along with a calcium halide having a composition ratio in the range of 5 mole % to 65 mole % to all metal halides enclosed in the envelope. p/36≦tₙ<1.5 is satisfied, where tₙ is a wall thickness (mm) of each thin tube and p is a bulb wall loading (W/cm²) at time when the metal halide lamp is lit.

Here, a rounded-off portion having a curvature radius in the range of 0.5 mm to 3.0 mm may be formed at a corner of each boundary between the main tube and the thin tubes, facing a discharge space.

In addition, a corner of each boundary between the main tube and the thin tubes, facing a discharge space, may be processed to form a chamfer having respective dimensions in a direction parallel to the axis of the envelope and in a direction perpendicular to the axis in the range of 0.5 mm to 3.0 mm.

Furthermore, the light emitting material further may contain at least one metal halide selected from the group consisting of cerium halides and praseodymium halides. The at least one metal halide has a composition ratio in the range of 0.5 mole % to 10 mole % to all metal halides enclosed in the envelope.

The luminaire of the present invention comprises: one of the above-mentioned metal halide lamps; a light fitting housing the metal halide lamp; and a lighting circuit for lighting the metal halide lamp.

### ADVANTAGEOUS EFFECTS OF THE INVENTION

In the case where (1) the envelope of the arc tube comprises a central tube and thin tubes with the thin tubes respectively positioned on each end of the central tube via the joining portions; and (2) in a cross section of the envelope along a plane including the axis in the longitudinal direction of the metal halide lamp, an angle α formed by a straight-line section of the inner surface of the central tube and a straight-line section of the inner surface of each joining portion is in the range of 85° to 115°, the curvature radius of the inner surface of each boundary region between the central tube and the joining portions is set in the range of 0.5 mm to 2.5 mm, or alternatively the above predetermined taper section is formed in each boundary region between the central tube and the joining portions. Herewith, even if rare earth halides are enclosed in the envelope, ceramic generated as a result of the inner surface of the thin tube being stripped can be precipitated and deposited on the inner surface of the boundary region between the central tube and the joining portions. Accordingly, over a long lighting period, it is possible to prevent the deposit from coming in contact with components each having a different thermal expansion coefficient from the deposit, such as electrode inductors and the like. As a result, the occurrence of cracks in the thin tubes, especially in the vicinity of the joining portions, which subsequently causes a leak, can be prevented, and therefore the operating life of the metal halide lamp can be extended.

In addition, the metal halide lamp of the present invention is capable of achieving extension of the operating life since (1) at least one rare earth metal halide selected from the group consisting of thulium (Tm), holmium (Ho) and Dysprosium (Dy) is contained as light-emitting material along with calcium halide; (2) the composition ratio of the calcium halide to the entire metal halides is in the range of 5 mole % to 65 mole %; and (3) p/36≦tn<1.5 is satisfied, where tn is the wall thickness of the thin tube of the translucent ceramic tube in mm and p is the bulb wall loading in W/cm² at the time when the metal halide lamp is lit. In other words, in the metal halide lamp equipped with an arc tube having an integrally-formed translucent ceramic tube where at least one rare earth metal halide selected from the group consisting of Tm, Ho and Dy having high corroding effects, especially, on the translucent ceramic tube is enclosed, it is possible, by containing calcium halide in a predetermined composition ratio, to (1) reduce corrosion of the inner surface of the thin tube responsible for the thin tube breakage; and (2) reduce the application of stress to the corroded part since the deposit to be generated on the inner surface of the thin tube is slashed corresponding to the corrosion reduction. In addition, by setting the wall thickness of each thin tube within an appropriate range in accordance with the bulb wall loading, the breakage of the thin tubes can be prevented in a reliable manner, which allows to achieve a long-lasting ceramic metal halide lamp.

### BRIEF DESCRIPTION OF THE DRAWINGS

FIG. 1 is a front view of a metal halide lamp according to a first embodiment of the present invention, with a part cut away to reveal the internal arrangements;

FIG. 2 is a front cross-sectional view of an arc tube used in the metal halide lamp;

FIG. 3 is an enlarged cross-sectional view of relevant parts of the arc tube used in the metal halide lamp;

FIG. 4 is another enlarged cross-sectional view of relevant parts of the arc tube used in the metal halide lamp;

FIG. 5 is another enlarged cross-sectional view of relevant parts of a different arc tube of the metal halide lamp;

FIG. 6 is a table showing a relationship of curvature radius R of the inner surface of a boundary region between a central tube and a joining portion of the arc tube with lighting period until crack formation;

FIG. 7 is a table showing a relationship between electrode projection length E₁ and minimum wall thickness t₁ of the arc tube;

FIG. 8 is a graph showing a relationship between the electrode projection length E₁ and the minimum wall thickness t₁ where cracks did not form;

FIG. 9 is an enlarged cross-sectional view of relevant parts of an arc tube used in a metal halide lamp according to a second embodiment of the present invention;

FIG. 10 is another enlarged cross-sectional view of relevant parts of the arc tube shown in FIG. 9;

FIG. 11 is a table showing a relationship of the size of a taper section formed on the inner surface of a boundary region between a central tube and a joining portion of the arc tube with lighting period until crack formation;

FIG. 12 is a schematic cross-sectional view showing a structure of a luminaire according to a third embodiment of the present invention;

FIG. 13 is a cross-sectional view showing a structure of an arc tube used in a metal halide lamp according to a fourth embodiment of the present invention;

FIG. 14 is an enlarged cross-sectional view of relevant parts showing a corrosion condition in a thin tube of the arc tube in the case when conventional light-emitting material was enclosed;

FIG. 15 is an enlarged cross-sectional view of relevant parts showing a corrosion condition in the thin tube of the arc tube according to the fourth embodiment;

FIG. 16 is a table showing a relationship among the amount of CaI₂ enclosed in the arc tube, bulb wall loading, and wall thickness of the thin tube;

FIG. 17 is a table showing a relationship among the composition ratio Mca (mole %) of CaI₂, the wall thickness of the thin tube t₁ (mm), and the bulb wall loading;

FIG. 18 is a table showing relationships of the bulb wall loading with the maximum wall thickness of the thin tube and with the minimum wall thickness;

FIG. 19 is a graph showing relationships of the bulb wall loading with the maximum wall thickness of the thin tube and with the minimum wall thickness;

FIG. 20 is a table showing relationships of the bulb wall loading with the maximum wall thickness of the main tube and with the minimum wall thickness of the main tube;

FIG. 21 is a graph showing relationships of the bulb wall loading with the maximum wall thickness of the main tube and with the minimum wall thickness;

FIG. 22 is a cross-sectional view of an integrally formed ceramic tube in which a rounded-off portion is provided on the inner surface of each boundary region between a main tube and thin tubes;

FIG. 23 is an enlarged cross-sectional view showing a condition of deposit in the case of when the integrally formed ceramic tube shown in FIG. 22 was used;

FIG. 24 shows a structure of an integrally-formed ceramic tube in which each boundary region, on the inner surface, between the main tube and thin tubes has been chamfered, instead of the rounded-off portion shown in FIG. 22 being provided;

FIGS. 25A and 25B show structures of arc tubes each using an assembled-and-sintered ceramic tube; and

FIG. 26 is an enlarged cross-sectional view of relevant parts of an arc tube used in a conventional metal halide lamp.

### EXPLANATION OF REFERENCES

1 metal halide lamp
2 outer tube
3, 39, 100, 300, 310 arc tube
4 sleeve
5 base
6 flare
7, 8 stem wire
9 electric power supply wire
10, 11, 113, 114 external lead wire
12 eyelet
13 shell
14, 15 metal plate
16, 40, 131 central tube
17, 41 joining portion
18, 45, 104, 105 thin tube
19, 44 envelope
20, 42 boundary region
21, 22, 170, 180 electrode
23, 120 discharge space
24, 25 electrode inductor
26 clearance gap
27, 111, 112 sealing material
28, 29, 172, 182 electrode rod
30, 31; 171, 181 electrode coil
32, 33, 109, 110 internal lead wire
34, 35, 117, 118 coil
36 electrode insertion slot
37, 153 deposit
38, 105A gouged area
43, 332 taper section
46 ceiling
47 light fitting
48 lighting circuit
49 base unit
50 reflection surface
51 lamp shade
52 socket

### BEST MODE FOR CARRYING OUT THE INVENTION

The best modes for carrying out the present invention are described below with reference to the drawings.

### First Embodiment

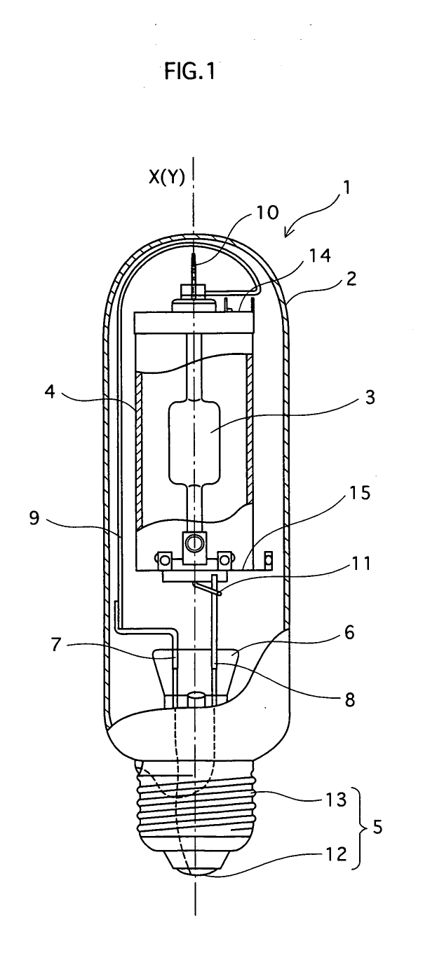

FIG. 1 shows a metal halide lamp (a ceramic metal halide lamp) 1 according to a first embodiment of the present invention. The metal halide lamp 1 with a rated lamp wattage (i.e. an input power) of 150 W comprises: an outer tube 2 having an overall length of 100 mm to 180 mm (e.g. 140 mm); an arc tube 3 positioned within the outer tube 2; a sleeve 4 positioned to enclose the entire arc tube 3, in order to protect the outer tube 2 against being damaged by broken pieces in the case of breakage of the arc tube 3; and a base 5 which is a screw base (E type) fixed at an end of the outer tube 2.

Note that the axis in the longitudinal direction of the arc tube 3 (X in FIG. 1) substantially coincides with the axis in the longitudinal direction of the outer tube 2 (Y in FIG. 1).

The outer tube 2 is a transparent, cylindrical tube made of hard glass, for example. One end of the outer tube 2 is closed and round in shape, and the other end is sealed by a flare 6 made of flint glass, for example. The inside of the outer tube 2 may be kept in vacuum, or may alternatively be filled with inert gas, if needed, such as nitrogen gas.

Part of two respective stem wires 7 and 8 made of, for example, nickel or mild steel is sealed at the flare 6. One ends of the stem wires 7 and 8 are led into the inside of the outer tube 2. One stem wire 7 of the two is electrically connected, via an electric power supply wire 9, to an external lead wire 10, which is one of two external lead wires 10 and 11 (to be hereinafter described) led out from the arc tube 3. The other stem wire 8 is directly and electrically connected to the other external lead wire 11. Within the outer tube 2, the arc tube 3 is supported by the two stem wires 7 and 8 and the electric power supply wire 9. The other end of the stem wire 7 is electrically connected to an eyelet 12 of the base 5, while the other end of the stem wire 8 is electrically connected to a shell 13 of the base 5. Each of the stem wire 7 and 8 is a single metal wire formed by welding a plurality of metal wires together.

The sleeve 4 is a transparent cylindrical tube made of, for example, quartz glass, and both ends of the sleeve 4 are open. The sleeve 4 is supported by being clamped at the open ends by publicly known supporting members, e.g. two metal plates 14 and 15. The metal plates 14 and 15 are mechanically connected to the external lead wires 10 and 11, respectively, to be thereby supported.

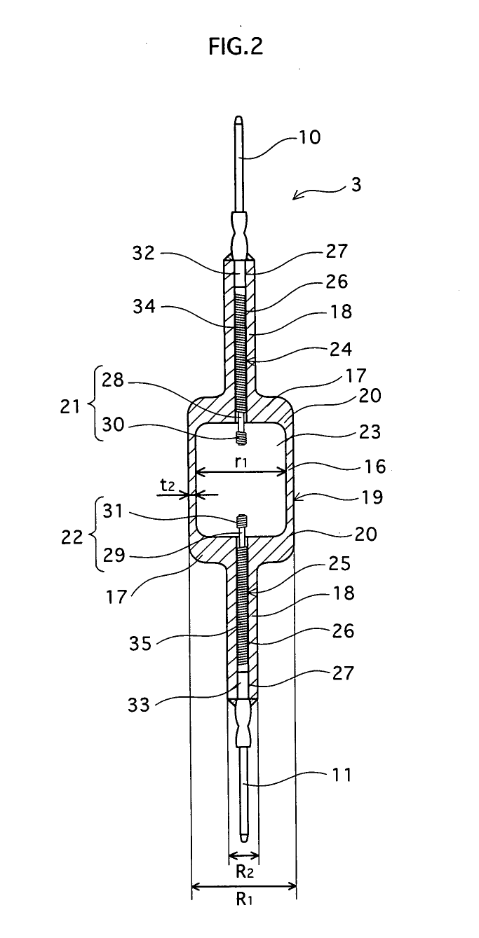

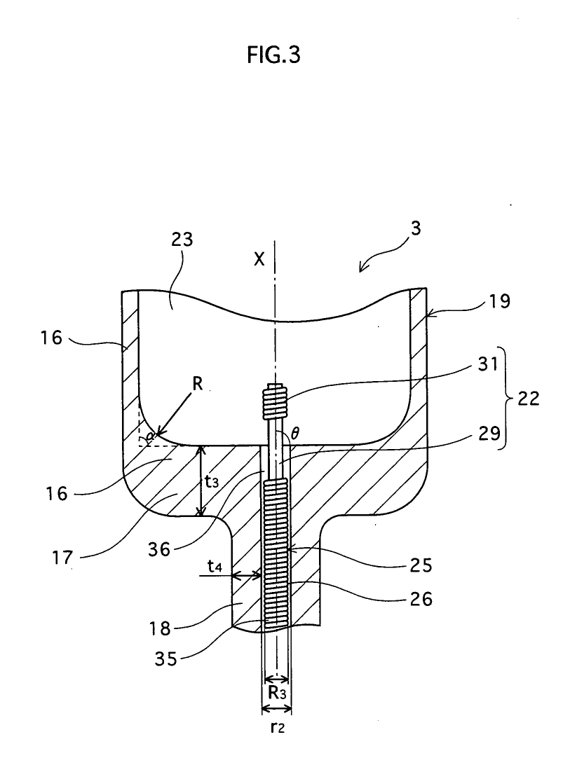

As shown in FIG. 2, the arc tube 3 has an envelope 19 made of, for example, polycrystalline alumina. The envelope 19 includes: a substantially cylindrical central tube 16 with an inner diameter r₁ of at least 5.5 mm or more; and two substantially cylindrical thin tubes 18 respectively formed onto each end of the central tube 16 via joining portions 17, and respectively having a diameter comparatively smaller (e.g. outer diameter R₂: 3 mm to 5 mm) than the outer diameter of the central tube 16 (e.g. outer diameter R₁: 13 mm to 25 mm). In a cross section of the arc tube 3 along a plane including the axis X in the longitudinal direction of the arc tube 3, an angle α formed by a straight-line section of the inner surface of the central tube 16 and a straight-line section of the inner surface of the joining portion 17 (refer to FIG. 3) is set in the range of 85° to 115° (e.g. 90°). The internal space of the central tube 16 and that of each thin tube 18 are communicated with each other. Regarding material for the envelope 19, a translucent ceramic, such as yttrium aluminum garnet (YAG), aluminum nitride or the like, can be used besides polycrystalline alumina.

In the arc tube 3, at least rare earth halides functioning as light-emitting material, mercury functioning as a buffer gas, and rare gas including such as argon gas and xenon gas functioning as a starting gas are respectively enclosed in specified quantities. As rare earth halides, lanthanoid iodides such as praseodymium iodide (PrI₃), cerium iodide (CeI₃), thulium iodide (TmI₃), holmium iodide (HoI₃), and dysprosium iodide (DyI₃) can be used other than scandium iodide (ScI₃) and yttrium iodide (YI₃). Besides such rare earth halides, various publicly known metal halides such as sodium iodide (NaI) and calcium iodide (CaI₂), for example, may accordingly be used as light-emitting material, if needed, in order to achieve a desired color property and the like. As a matter of course, rare earth halides applicable here are not limited to iodides, and part of, or the entire rare earth halides can be composed of bromides, instead. In particular, it is desirable that an alkaline-earth metal halide be enclosed for reasons described below.

Note that the bulb wall loading of the arc tube 3 (input power per unit inner surface area of the arc tube 3 with the thin tubes 18 excluded) is set in the range of 15 W/mm² to 45 W/mm².

In the present embodiment, the central tube 16, joining portions 17 and thin tubes 18 which make up the envelope 19 are integrally formed in one piece with no joints. However, as described hereinafter, the envelope 19 may be made by, first, separately forming the thin tubes 18 while integrally forming only the central tube 16 and the joining portions 17, and subsequently assembling and joining the respective components by shrink-fit process.

The inner diameter r₁ of the central tube 16 is, as described above, set to 5.5 mm or more, however it is generally preferable, from the aspect of compactness and the like, that the inner diameter r₁ be no more than 30 mm. In addition, the minimum wall thickness t₂ of the central tube 16 is preferably set to 0.4 mm or more with the object of offering mechanical strength and resistance to vapor pressure of enclosed materials while the lamp is lit.

The inner surface of the central tube 16 is connected to the inner surface of each joining portion 17 via a smooth, concave curved surface so as to form a rounded-off corner, as shown in FIG. 3. The curvature radius R of the inner surface of each boundary region 20, where the inner surface of the central tube 16 and the inner surface of one of the joining portions 17 meet, is set in the range of 0.5 mm to 2.5 mm.

In the example shown in FIG. 3, the inner surface of the joining portion 17 is substantially planar, being perpendicular to the axis X in the longitudinal direction of the arc tube 3, except for the boundary region between the central tube 16 and the joining portion 17 as well as between the joining portion 17 and the thin tube 18. However, the inner surface of the joining portion 17 may be curved and tapered toward the thin tube 18. That is, in a cross section of the envelope 19 along a plane including the axis X, the shape of the inner surface of the envelope 19, except for the thin tubes 18, is substantially rectangular or substantially square with each of the four corners rounded off. Note however that, in the case when the inner surface of each joining portion 17 is curved with a tapering configuration, an angle θ (see FIG. 3) between the axis X and the straight-line section of the joining portion 17 in the above cross section is no less than 75° but no more than 95°.

Note that the shape of the outer surface of each joining portion 17 is not particularly limited. However, if the wall thickness t₃ of the joining portion 17 is too large, the quantity of heat conducted from a discharge space 23 (to be hereinafter described) to each joining portion 17 increases while the lamp is lit, which results in an increase in heat loss. As a result, the vapor pressure of the light-emitting metals cannot be elevated enough and consequently the luminous efficiency may possibly decrease. On the other hand, if the wall thickness t₃ of each joining portion 17 is too small, the mechanical strength and resistance to vapor pressure of enclosed materials while the lamp is lit may possibly be insufficient. In view of these points, in a cross section of the envelope 19 along a plane including the axis X, the minimum wall thickness t₃ of the joining portion 17 where the straight-line section of the inner surface of the joining portion 17 is substantially parallel to the straight-line section of the outer surface thereof is preferably set in the range of 1 mm to 2.5 mm, for example.

As shown in FIG. 2, the electrodes 21 and 22 formed on the tips of the electrode inductors 24 and 25 (to be hereinafter described), respectively, are placed substantially opposite each other on the approximately same axis (the axis X) in the space surrounded by the central tube 16 and the joining portions 17, and the discharge space 23 is formed therein.

The electrode inductors 24 and 25 are respectively inserted into the thin tubes 18, and fixed by sealing material 27 only at an end of each thin tube 18, located further from the central tube 16. The sealing material 27 made of glass frit is poured from the end of each thin tube 18 into a clearance gap 26 between the thin tube 18 and the electrode inductor 24/25. The depth of the sealing material, poured into the clearance gap 26 from the end of the thin tube 18 which is located further from the joining portion 17, i.e. the sealing length, is 3 mm to 6 mm.

The inner diameter r₂ of each thin tube 18 is generally, in the manufacturing process of the arc tube 3, set to be the minimum which yet offers sufficient room for the electrode inductors 24 and 25 to be inserted into the thin tubes 18. The inner diameter r₂ is set to “the minimum” in order to prevent the following situation. That is, if large clearance gaps 26 are formed therebetween after the electrode inductors 24 and 25 are inserted into the thin tubes 18, a significant amount of metal halides, which are light-emitting material, seep into the clearance gaps 26, which results in a decrease in the amount of metals contributing to light emission while the lamp is lit. However, in order to insert the electrode inductors 24 and 25 into the thin tubes 18, there is no choice other than making the inner diameter r₂ of the thin tubes 18 larger than the maximum outer diameter R₃ of the electrode inductors 24 and 25 (see FIG. 3) in order to facilitate easier insertion, as described above. Thus, the clearance gaps 26 are inevitably formed between the thin tubes 18 and the electrode inductors 24 and 25. Usually, the clearance gaps 26 formed between the thin tubes 18 and the electrode inductors 24 and 25 are respectively 0.05 mm to 0.5 mm. However, in the manufacturing process, it is difficult to insert the electrode inductors 24 and 25 into the thin tubes 18 and fix them so that the axis of the electrode inductors 24 and 25 in the longitudinal direction completely coincides with the axis of the thin tubes 18 in the longitudinal direction (i.e. the axis X). As a matter of fact, it is often the case that the electrode inductors 24 and 25 are positioned in the thin tubes 18, with their axes misaligned from the axis X.

The wall thickness t₄ of the thin tubes 18 (see FIG. 3) is set at no less than 0.7 mm, for example, with the object of offering mechanical strength. On the other hand, if the wall thickness t₄ is too large, the quantity of heat conducted from the discharge space 23 to the thin tubes 18 while the lamp is lit increases and thereby heat loss also increases, which possibly leads to a decrease in the luminous efficiency. Accordingly, it is desirable that the wall thickness t₄ of the thin tubes 18 be set at no more than 2.0 mm, for example.

As shown in FIG. 2, the electrode inductors 24 and 25 each have a maximum outer diameter R₃ (see FIG. 3) of 0.9 mm, for example. Each of the electrode inductors 24 and 25 includes: the electrode 21/22; an internal lead wire 32/33; the external lead wire 10/11; and a coil 34/35. The electrodes 21 and 22 are respectively composed of: a tungsten electrode rod 28/29 having a diameter of 0.5 mm; and a tungsten electrode coil 30/31 mounted on the tip of the electrode rod 28/29. The internal lead wires 32 and 33 are made of molybdenum, for example, and an end of the internal lead wire 32/33 is connected to the electrode rod 28/29. The external lead wires 10 and 11 are made of niobium, for example, and each is connected to the other end of the internal lead wire 32/33 led to the outside of the thin tubes 18. The coils 34 and 35 are made of molybdenum, and are respectively wound around part of the electrode rods 28 and 29. The coil 34/35 fills each of the clearance gaps 26 between part of the electrode rod 28/29 and each thin tube 18 to a maximum extent to thereby prevent the metal halides from seeping into the clearance gaps 26.

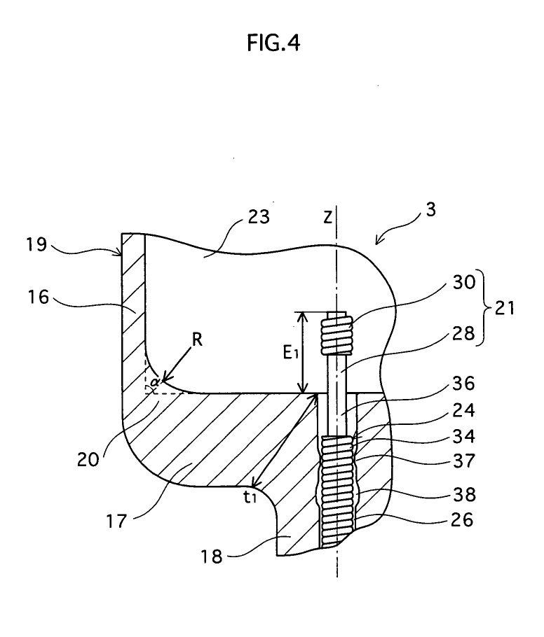

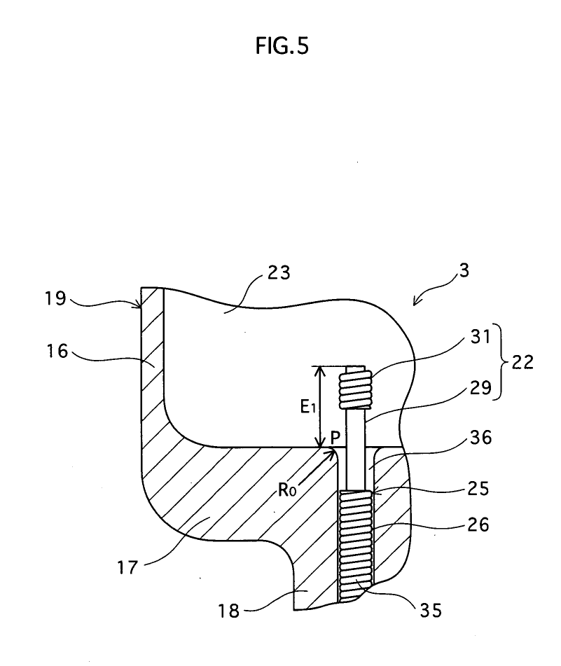

Here, the projection length of the electrodes 21 and 22 (hereinafter, simply referred to as an “electrode projection length E₁”) is E₁ (mm) (see FIGS. 4 and 5) while the minimum wall thickness of each boundary region between the joining portions 17 and thin tubes 18 (a “minimum wall thickness t₁”) is t₁ (mm) (see FIG. 4). In this situation, it is desirable that the electrode projection length E₁ and the minimum wall thickness t₁ be set to values found within an area defined by lines connecting four points of (E₁, t₁)=(0.5, 1.0), (0.5, 3.5), (5.0, 3.5), and (5.0, 0.5) for the reasons, as described hereinafter.

Note that the “electrode projection length E₁” phrased in this specification means, as shown in FIG. 4, a projecting length of the electrode inductors 24 and 25 out of electrode insertion slots 36, where the electrode inductors 24 and 25 are inserted. In other words, it is the shortest distance from an open end of each electrode insertion slot 36 facing the discharge space 23 to an imaginary plane lying at the tip of the electrode 21/22 and perpendicular to the axis Z in the longitudinal direction of the electrode inductors 24 and 25. Note however that, in the case when the “open end of each electrode insertion slot 36 facing the discharge space 23” has a predetermined curvature radius R₀, as shown in FIG. 5, the open end is assumed to be the edge of the region having the curvature radius R₀, located closer to the joining portion 17 (i.e. point P in FIG. 5).

In addition, the “minimum wall thickness t₁” corresponds to the smallest radius of concentric circles having a common center at a given point of the open end of the electrode insertion slot 36 and having contact with the outer surface of the envelope 19. Note that numeric values of the “electrode projection length E₁” and the “minimum wall thickness t₁” are values obtained at the initial stage of lighting, namely when the components of the arc tube 3 have not come under the influence of lighting, being free from deformation and the like.

Note that electrode inductors made of well-known materials or having a well-known structure can be used instead of the electrode inductors 24 and 25 comprising the electrodes 21 and 22, the molybdenum internal lead wires 32 and 33, the niobium external lead wires 10 and 11 and the molybdenum coils 34 and 35.

The following gives an account of the reason why the curvature radius R of the inner surface of each boundary region 20 between the central tube 16 and the joining portions 17 (hereinafter, simply referred to as a “curvature radius R”) is set in the range of 0.5 mm to 2.5 mm.

A plurality of the metal halide lamps 1 with a rated lamp wattage of 150 W of the above first embodiment according to the present invention were prepared as follows. The curvature radius R of the metal halide lamps 1 was variously changed: 0.3 mm (hereinafter, referred to as Comparative Example 1); 0.5 mm (Practical Example 1); 1.0 mm (Practical Example 2); 1.8 mm (Practical Example 3); 2.0 mm (Practical Example 4); 2.5 mm (Practical Example 5); and 2.7 mm (Comparative Example 2), and ten lamps were prepared for each example class of the curvature radius R.

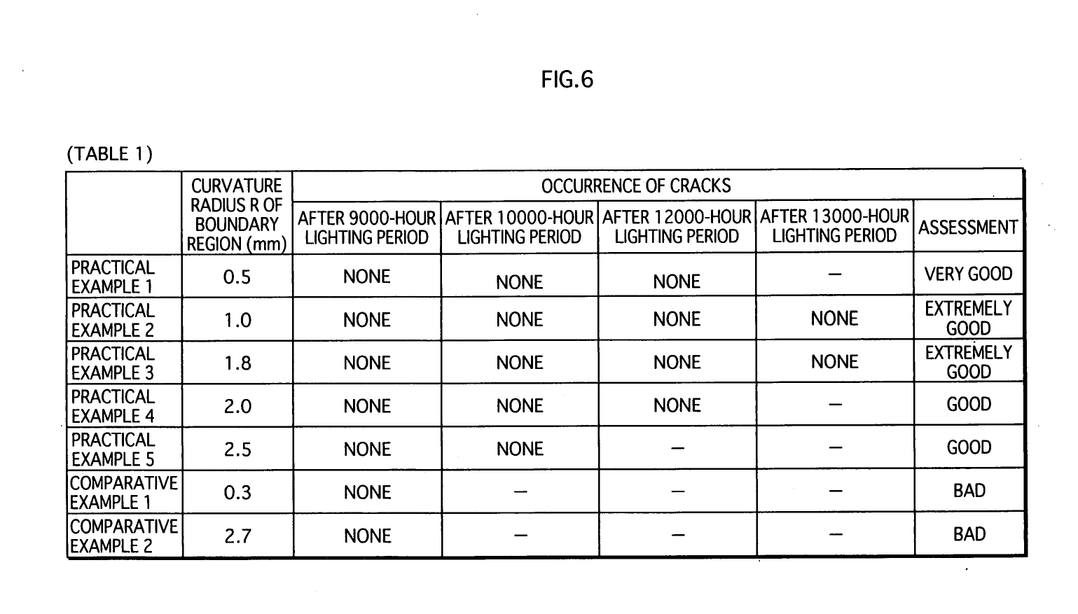

Then, a life test repeating cycles, each of which consists of a 5.5-hour-lighting phase and a 0.5-hour-light-off phase, was conducted with respect to each prepared lamp. Subsequently, occurrence of cracks in the thin tube 18, at a part close to the joining portion 17, was examined at lighting periods of 9000 hours, 10000 hours, 12000 hours, and 13000 hours. The results of the examination are shown in Table 1 of FIG. 6.

Note that Practical Examples 1 to 5 and Comparative Examples 1 and 2 all have the same structure except for the curvature radius R. Each of the major components measures as follows: the outer diameter R₁ of the central tube 16, 12.3 mm; the inner diameter r₁ of the central tube 16, 11.0 mm; the outer diameter R₂ of each thin tube 18, 3.0 mm; the inner diameter r₂ of each thin tube 18, 1.0 mm; the maximum outer diameter R₃ of the electrode inductors 24 and 25, 0.9 mm; the electrode projection length E₁, 0.5 mm; and the minimum wall thickness t₁, 1.0 mm. In addition, enclosed in the arc tube 3 as light-emitting material are 12 wt % dysprosium iodide (DyI₃), 12 wt % thulium iodide (TmI₃), 12 wt % holmium iodide (HoI₃), 16 wt % thallium iodide (TiI₃), and 48 wt % sodium iodide (NaI), totaling 5.2 mg. Furthermore, 10 mg of mercury is also enclosed therein while argon gas being enclosed to be 13 kPa at 300 K.

In the columns of “OCCURRENCE OF CRACKS” in Table 1, “-” denotes that the arc tubes 3 of an example class caused a leak due to crack formation and thereby became unlit before a corresponding lighting period elapsed.

Each lamp was lit in a vertical position with the base 5 placed on the upper side. In this examination, all crack formation within the thin tube 18, located close to the joining portion 17, took place in the thin tube 18 at a lower position when the lamp was lit in the vertical position, as described hereinafter.

As is clear from Table 1, in any of Practical Examples 1 to 5, no cracks formed within the thin tube 18, located close to the joining portion 17, after a 10000-hour lighting period. In particular, Practical Examples 1 to 4 were free from such cracks even after a 12000-hour lighting period, and furthermore Practical Examples 2 and 3 were still free from cracks after a 13000-hour lighting period. Practical Examples 1 and 4 caused a leak and became unlit before a 13000-hour lighting period, while Practical Example 5 becoming unlit due to the occurrence of a leak before a 12000-hour lighting period.

On the other hand, in Comparative Examples 1 and 2, although no cracks were found in the thin tube 18, located close to the joining portion 17, after a 9000-hour lighting period, cracks formed therein before a 10000-hour lighting period, which resulted in a leak and caused the lamps to become unlit.

Then, each arc tube 3 of the following example classes was cut along a plane including the axis X in the longitudinal direction of the arc tube 3, and the inner surface was observed under a scanning electron microscope (SEM): Practical Examples 3 and 4 after a 13000-hour lighting period; and arc tubes 3 of Practical Examples 1, 2 and 5 and Comparative Examples 1 and 2, becoming unlit. The following was found through the SEM observation.

Concerning all of Practical Examples 1 to 5 and Comparative Examples 1 and 2, a nearly equal sized gouge was found in an area, within the inner surface of the thin tube 18, 3 mm to 10 mm below the open end of the electrode insertion slot 36 facing the discharge space 23.

Especially, as to Comparative Examples 1 and 2, alumina gouged from the area was collectively deposited on the inner surface of the thin tube 18, located in the vicinity of the gouged area, on the side closer to the joining portion 17. Deposit 37 was in contact with the electrode inductor 24, in particular with the coil 34. Here, cracks formed, starting at the point of contact between the deposit 37 and the electrode inductor 24.

Note that a reference numeral 38 in FIG. 4 denotes the gouged area. The phenomenon is considered due to reaction with the enclosed rare earth halides.

As to Practical Example 1, although part of the gouged alumina was only slightly deposited on the inner surface of the thin tube 18, located in the vicinity of the gouged area 38, on the side closer to the discharge space 23, the majority of the gouged alumina was deposited close to the inner surface of the boundary region 20 between the central tube 16 and the joining portion 17. As stated above, the alumina deposited inside the thin tube 18 was in contact with the electrode inductor 24, and cracks formed, starting at the contact point.

As to Practical Examples 2 and 3, the gouged alumina was deposited only on the inner surface of the boundary region 20 between the central tube 16 and the joining portion 17 (i.e. the concave curved surface having the curvature radius R), and no deposit was found on the inner surface of the thin tube 18.

As to Practical Examples 4 and 5, although part of the gouged alumina was only slightly deposited on the inner surface of the thin tube 18, located in the vicinity of the gouged area 38, on the side closer to the discharged space 23, the majority of the gouged alumina was deposited close to the inner surface of the boundary region 20 between the central tube 16 and the joining portion 17. As stated above, the alumina deposited inside the thin tube 18 was in contact with the electrode inductor 24, and cracks formed, starting at the contact point.

According to these results, it is considered that, by providing a rounded-off corner with an adequate curvature radius on the inner surface of the boundary region 20 between the central tube 16 and the joining portion 17, temperature T₁ of the inner surface of the boundary region 20 can be set lower than temperature T₂ of the inner surface of the thin tube 18, located in the vicinity of the gouged area 38, on the side closer to the discharge space 23. As a result, the gouged alumina can be precipitated not on the inner surface part of the thin tube 18 with the temperature T₂, but on the inner surface of the boundary region 20 with the temperature T₁.

However, if so, in Comparative Example 1, the gouged alumina should have been precipitated not at the inner surface part of the thin tube 18, located in the vicinity of the gouged area 38, on the side closer to the discharge space 23, but on the inner surface of the boundary 20 between the central tube 16 and the joining portion 17. However, this was not the case for Comparative Example 1, and the reason why cracks formed between lighting periods of 9000 hours and 10000 hours and thereby a leak was caused is considered as follows. The curvature radius R of the boundary region 20 was too small, and as a result, a capillary phenomenon of a sort was brought about at the boundary region 20, which led to a large quantity of surplus metal halides in a liquid form accumulating at the boundary region 20. The accumulating metal halides in a liquid form blocked the precipitation of the gouged alumina at the boundary region 20, and accordingly, the gouged alumina was precipitated and deposited on a part of the inner surface of the thin tube 18, having the second lowest temperature, i.e. the vicinity of the gouged area 38, on the side closer to the discharge space 23. This can also be speculated based on the observation results of Practical Example 1, which are different from those of Practical Examples 2 to 5. That is, as to Practical Example 1, none of the gouged alumina was precipitated on the boundary region 20 between the central tube 16 and the joining portion 17, but a slight amount of the gouged alumina was precipitated and deposited on the inner surface of the joining portion 17, a little away from the boundary region 20.

It was found that, when the inner diameter r₁ of the central tube 16 was smaller than 5.5 mm, the alumina generated as a result of a part of the inner surface of the thin tube 18 being stripped could not be precipitated and deposited on the inner surface of the boundary region 20 between the central tube 16 and the joining portion 17. This is thought to be attributable to the boundary region 20 being positioned too close to the electrodes 21 and 22 when the inner diameter r₁ of the central tube 16 was smaller than 5.5 mm, which resulted in an increase in the temperature T₁ of the inner surface of the boundary region 20. Accordingly, in order to precipitate and deposit the alumina generated as above on the inner surface of the boundary region 20 between the central tube 16 and the joining portion 17, the inner diameter r₁ of the central tube 16 needs to be at 5.5 mm or more.

Even if rare earth halides are enclosed, by setting the inner diameter r₁ of the central tube 16 at 5.5 mm or more as well as setting the curvature radius R of the inner surface of the boundary region 20 in the range of 0.5 mm to 2.5 mm, the alumina generated as a result of the part of the inner surface of the thin tube 18 being stripped can be precipitated and deposited on the inner surface of the boundary region 20 between the central tube 16 and the joining portion 17. Herewith, it is possible to prevent the deposit 37 from coming in contact with components each having a different thermal expansion coefficient from the deposit 37, such as the electrode inductors 24 and 25, over a long lighting period. As a result, the occurrence of cracks, especially in the vicinity of the joining portion 17, causing a leak can be prevented, and accordingly the operating life of the metal-halide lamp can be extended.

As clear from Table 1, it is more preferable that the curvature radius R of the inner surface of the boundary region 20 between the central tube 16 and the joining portion 17 be set in the range of 0.5 mm to 2.0 mm in order to further extend the operating life. In order to achieve yet additional extension of the operating life, it is furthermore preferable to set the curvature radius R in the range of 1.0 mm to 1.8 mm.

The following gives an account of the reason why it is desirable that an alkaline earth metal halide be enclosed in the envelope 19.

Ten of metal halide lamps with a rated lamp wattage of 150 W were prepared as Practical Example 6, each having the same structure as those of Practical Example 1 except for the enclosed light-emitting material. Here, enclosed in the arc tubes 3 as light-emitting material were 7.7 wt % dysprosium iodide (DyI₃), 7.6 wt % thulium iodide (TmI₃), 7.6 wt % holmium iodide (HoI₃), 11.3 wt % thallium iodide (TiI₃), 40.2 wt % sodium iodide (NaI), and 25.6 wt % calcium iodide (CaI₂), totaling 7.2 mg.

Then, a life test repeating cycles, each of which consists of a 5.5-hour-lighting phase and a 0.5-hour-light-off phase, was conducted with respect to each prepared lamp. Subsequently, each of the arc tubes 3 after a 12000-hour lighting period was cut along a plane including the axis X in the longitudinal direction of the arc tube 3, and the inner surface was observed under a scanning electron microscope (SEM) to reveal the following.

That is, as to Practical Example 6, the gouged area, which was formed on the inner surface of the thin tube 18 as a result of reaction with the rare earth metal halides, was significantly smaller as compared to the case in Practical Example 1. Accordingly, it is considered that the above-described reaction between the alumina forming the envelope 19 and the rare earth halides can be reduced by including calcium iodide in the metal halides enclosed in the envelope 19. Thus, it is possible to slash the amount of the gouged alumina generated by the reaction with the rare earth metal halides, which achieves further extension of the operating life. At the same time, the envelope 19 is prevented from becoming thinner due to the reaction with the rare earth metal halides, which avoids a decrease in mechanical strength of the reacted area and reduces the likelihood of breakage of the envelope 19. It has been confirmed that this effect can be obtained not only when calcium iodide is used, but also when, let alone calcium bromide, an alkaline earth metal halide other than calcium halide, such as magnesium halide or strontium halide, is used. In particular, in the case when calcium halide is employed as an alkaline earth metal halide, an increase in the red color component is achieved besides the above effect, and this allows to enhance the color rendering.

In sum, it is desirable to enclose an alkaline earth metal halide in the envelope 19 in order to: (1) achieve further extension of the operating time of the metal halide lamp by reducing reaction between alumina forming the envelope 19 and the rare earth halides, and thereby slashing the amount of the gouged alumina generated by the reaction with the rare earth metal halides; and (2) prevent the envelope 19 from becoming thinner due to the reaction with the rare earth metal halides and thereby avoid a decrease in mechanical strength of the reacted area and reduces the likelihood of breakage of the envelope 19.

The following gives an account of the reason why it is desirable that the electrode projection length E₁ (mm) and the minimum wall thickness t₁ (mm) be set to values found within an area defined by lines connecting four points of (E₁, t₁)=(0.5, 1.0), (0.5, 3.5), (5.0, 3.5), and (5.0, 0.5).

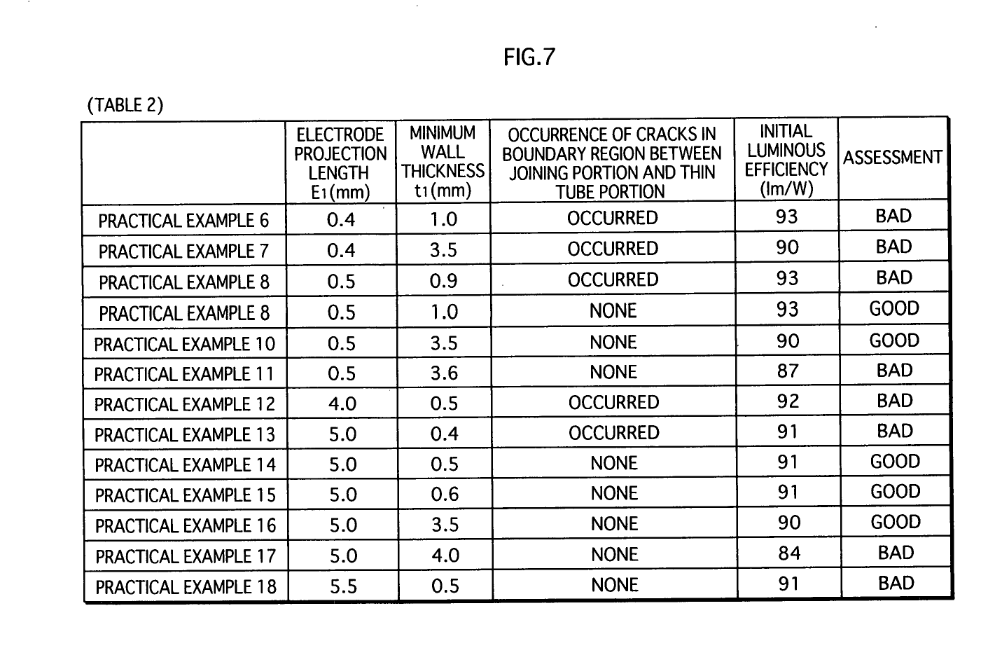

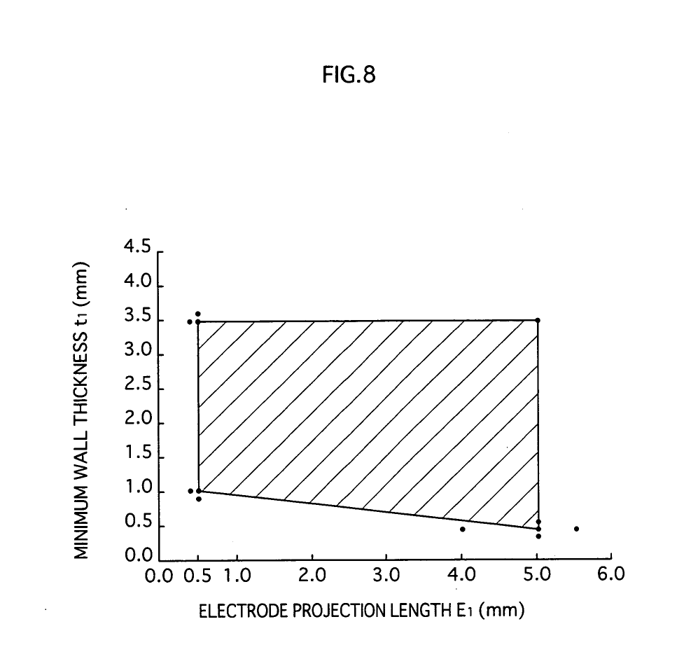

A plurality of the metal halide lamps were prepared, each of which has the same structure as of Practical Example 2 (rated lamp wattage: 150 W) in Table 1 above except for the electrode projection length E₁ (mm) and the minimum wall thickness t₁ (mm). The electrode projection length E₁ (mm) and the minimum wall thickness t₁ (mm) were variously changed as shown in Table 2 of FIG. 7 as well as FIG. 8, and ten lamps were prepared for each example class.

Then, a life test repeating cycles, each of which consists of a 5.5-hour-lighting phase and a 0.5-hour-light-off phase, was conducted with respect to each prepared lamp. Then, occurrence of cracks in the boundary region 20 between the joining portion 17 and the thin tube 18 after a lighting period of 13000 hours and an initial luminous efficiency (lm/W) were respectively examined. The results of the examination are shown in Table 2 of FIG. 7.

Note that the “initial luminous efficiency” means a luminous efficiency when a lighting period of 100 hours elapsed, and each numeric value shown under the labeled column in Table 2 is the average value for ten samples of a corresponding example class. In terms of the assessment criterion for the luminous efficiency, it was thought that the lamps were acceptable if the luminous efficiency was no less than that of a conventional ceramic metal halide lamp, i.e. 90 lm/W.

“Lumen maintenance (%)” to be hereinafter described is a proportion of the lamp's luminous flux (lm) produced after a set time to the luminous flux of the lamp after a 100-hour lighting period.

Each lamp was lit in a vertical position with the base 5 placed on the upper side. In this examination, crack formation took place in both upper and lower boundary regions between the joining portions 17 and the thin tubes 18, as described hereinafter.

As is clear from Table 2, as to Practical Examples 6, 7, 8, 12 and 13, cracks formed in the boundary regions between the joining portions 17 and the thin tubes 18 after a lighting period of 13000 hours, which caused a leak. On the other hand, as to Practical Examples 9, 10, 11, 14, 15, 16, 17 and 18, no cracks were found at the boundary regions between the joining portions 17 and the thin tubes 18 after a lighting period of 13000 hours.

Then, each of the arc tubes 3 of the practical examples causing a leak was cut along a plane including the axis X in the longitudinal direction of the arc tube 3, and the inner surface was observed under a scanning electron microscope (SEM). However, there was no sign that alumina gouged due to reaction with the rare earth metal halides was deposited in the boundary regions between the joining portions 17 and the thin tubes 18 and was in contact with the electrode inductors 24 and 25. Subsequently, the cause of the cracks in Practical Examples 6, 7, 8, 12 and 13 was examined and considered as follows. In the clearance gap of Practical Examples 6, 7 and 8, the electrodes 21 and 22 reaching a high temperature while the lamp was lit were positioned too close to the boundary regions between the joining portions 17 and thin tubes 18. As a result, temperature difference of the boundary regions between when the lamp was on and when it was off became significant. This caused high stress on the boundary regions, and thereby cracks formed. On the other hand, in the case of Practical Examples 12 and 13, the distance from the electrodes 21 and 22 to the boundary regions between the joining portions 17 and the thin tubes 18 was longer as compared to the case of Practical Examples 6, 7 and 8, and therefore the stress exerted on the boundary regions might be not very significant. Nonetheless, since the minimum wall thickness t₁ was set small in these practical examples, cracks formed by the relatively low stress. In the case of Practical Examples 9, 10, 11, 14, 15, 16, 17 and 18, however, even though the minimum wall thickness t₁ was small, high stress was not applied to the boundary regions since the temperature difference was accordingly small. Yet at the same time, even if the temperature difference might be significant and reasonably high stress was applied to the boundary regions, the minimum wall thickness t₁ was thick enough to resist the stress.

Furthermore, as is clear from Table 2, in all Practical Examples 6, 7, 8, 9, 10, 12, 13, 14, 15, 16 and 18, the initial lumen maintenance was 90 lm/W or more, and thus satisfied the above assessment criterion. On the other hand, as to Practical Examples 11 and 17, the initial luminous efficiency was less than 90 lm/W and did not meet the assessment criterion.

As to Practical Examples 1, and 7 to 17, the lumen maintenance after a 6000-hour lighting period was 80% or more, which is comparable with the lumen maintenance of a conventional ceramic metal halide lamp after a 6000-hour lighting period. On the other hand, as to Practical Example 18, the lumen maintenance after 6000-hour lighting period was only 75%, which falls short of the lumen maintenance of a conventional ceramic metal halide lamp after a 6000-hour lighting period. In addition, as to Practical Example 18, particularly the inner surface of the joining portions 17 was significantly blackened.

The cause of these results was thought to be as follows.

In the case of Practical Examples 11 and 17, the minimum wall thickness t₁ was too large, and therefore the quantity of heat conducted from the discharge space 23 to the boundary regions increased while the lamp was lit, which resulted in an increase in heat loss. As a result, the luminous efficiency was decreased. On the other hand, as to Practical Examples 6, 7, 8, 9, 10, 12, 13, 14, 15, 16 and 18, the minimum wall thickness t₁ was adequate, and therefore the quantity of heat conducted from the discharge space 23 to the boundary regions while the lamp was lit was low. As a result, an increase in heat loss was avoided, which resulted in achieving desired luminous efficiency. However, Practical Example 18 exhibited low lumen maintenance, unlike in the case of other practical examples, and the cause is thought to be as follows. That is, in general, heat convection in the discharge space 23 occurs mainly between the electrodes 21 and 22 while the lamp is lit, and the heat convection accelerates a halogen cycle in the discharge space 23. Accordingly, even if tungsten, a constituent material of the electrodes 21 and 22, disperses from the electrodes 21 and 22 in a high temperature state while the lamp is lit, the halogen cycle prevents the tungsten from being deposited and blackening the inner surface of the arc tube 3, which in turn prevents a decrease in lumen maintenance. However, when the electrode projection length E₁ is too long, as is the case with Practical Example 18, the heat convection between the electrodes 21 and 22 becomes less likely to occur in the vicinity of the open end of each electrode insertion slot 36. As a result, as to Practical Example 18, the function of the halogen cycle described above was decreased at the regions, which caused blackening. This can also be seen from the fact that the inner surface of the joining portions 17 of Practical Example 18 was significantly blackened, as described above.

In sum, the following are what turned up: by setting the electrode projection length E₁ (mm) and the minimum wall thickness t₁ (mm) to values found within an area defined by lines connecting four points of (E₁, t₁)=(0.5, 1.0), (0.5, 3.5), (5.0, 3.5) and (5.0, 0.5), i.e. the area marked with diagonal lines in FIG. 8, it is possible to (1) prevent, without decreasing the luminous efficiency and lumen maintenance, high stress due to the lamp being repeatedly lit on and off from being applied to the boundary regions between the joining portions 17 and thin tubes 18; and accordingly (2) prevent cracks from forming in the boundary regions due to the stress and the thereby caused leak. As a result, further extension of the operating life can be achieved.

Thus, it is desirable to set the electrode projection length E₁ (mm) and the minimum wall thickness t₁ (mm) to values found within an area defined by lines connecting four points of (E₁, t₁)=(0.5, 1.0), (0.5, 3.5), (5.0, 3.5) and (5.0, 0.5), in order to prevent, without decreasing the luminous efficiency and lumen maintenance, cracks from forming in the boundary regions between the joining portions 17 and the thin tubes 18 and the thereby caused leak, and achieve further extension of the operating life.

### Second Embodiment

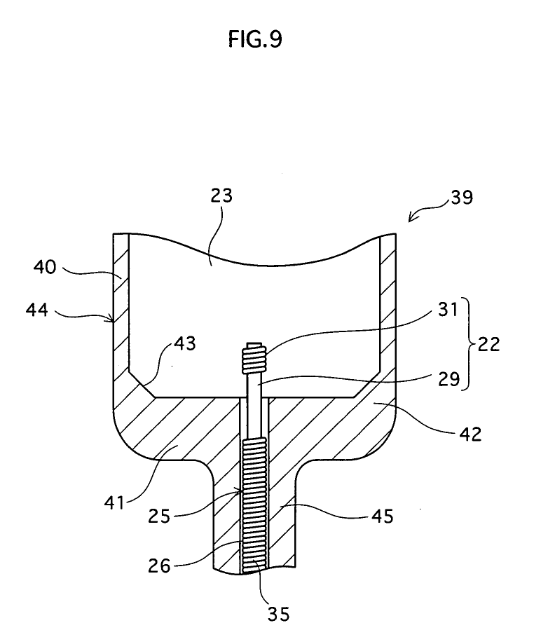

FIG. 9 shows a metal halide lamp (rated lamp wattage: 150 W) according to a second embodiment of the present invention. The metal halide lamp of the second embodiment has the same structure as the metal halide lamp 1 (rated lamp wattage: 150 W) according to the first embodiment of the present invention except for a taper section 43 being provided. The taper section 43 having a shape as if the tip of a circular cone were chopped off is formed along the inner surface of a boundary region 42 between a central tube 40 and a joining portion 41 of an arc tube 39, instead of the rounded-off corner with a curvature radius R of 0.5 mm to 2.5 mm being provided.

Note that reference numerals 44 and 45 in FIG. 9 indicate an envelope and a thin tube, respectively.

As shown in FIG. 10, in a cross section of the arc tube 39 along a plane including the axis X in the longitudinal direction of the arc tube 39, a boundary point between the inner surface of the central tube 40 and the taper section 43 (i.e. an intersecting point of a straight line including the inner surface of the central tube 40 with a straight line including the taper section 43) is a point A; a boundary point between the inner surface of the joining portion 41 and the taper section 43 (i.e. an intersecting point of a straight line including the inner surface of the joining portion 41 with the straight line including the taper section 43) is a point B; and an intersecting point of the straight line including the inner surface of the central tube 40 with a line extending perpendicularly from the point B towards the straight line is a point C. In this situation, the taper section 43 is set so that the line AC and line BC are respectively in the range of 0.5 mm to 2.5 mm in length. Here, being within this range, the line AC and line BC may either have the same length, or different lengths.

In the cross section of the arc tube 39 along a plane including the axis X in the longitudinal direction of the arc tube 39, an angle α formed by a straight-line section of the inner surface of the central tube 40 and a straight-line section of the inner surface of the joining portion 41 is set in the range of 85° to 115° (e.g. 90°).

The following gives an account of the reason why the lengths of line AC and line BC are respectively set in the range of 0.5 mm to 2.5 mm.

First, by using the structure of the metal halide lamp (rated lamp wattage: 150 W) of the second embodiment according to the present invention, ten lamps were prepared for each of the example classes while the length of the line AC and line BC were variously changed among the example classes.

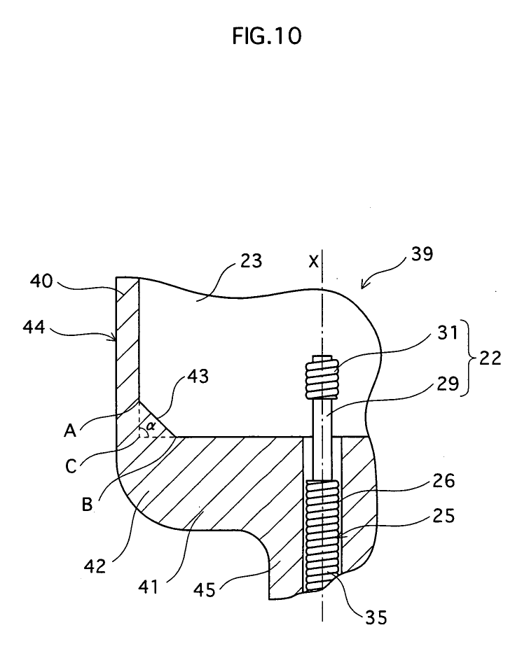

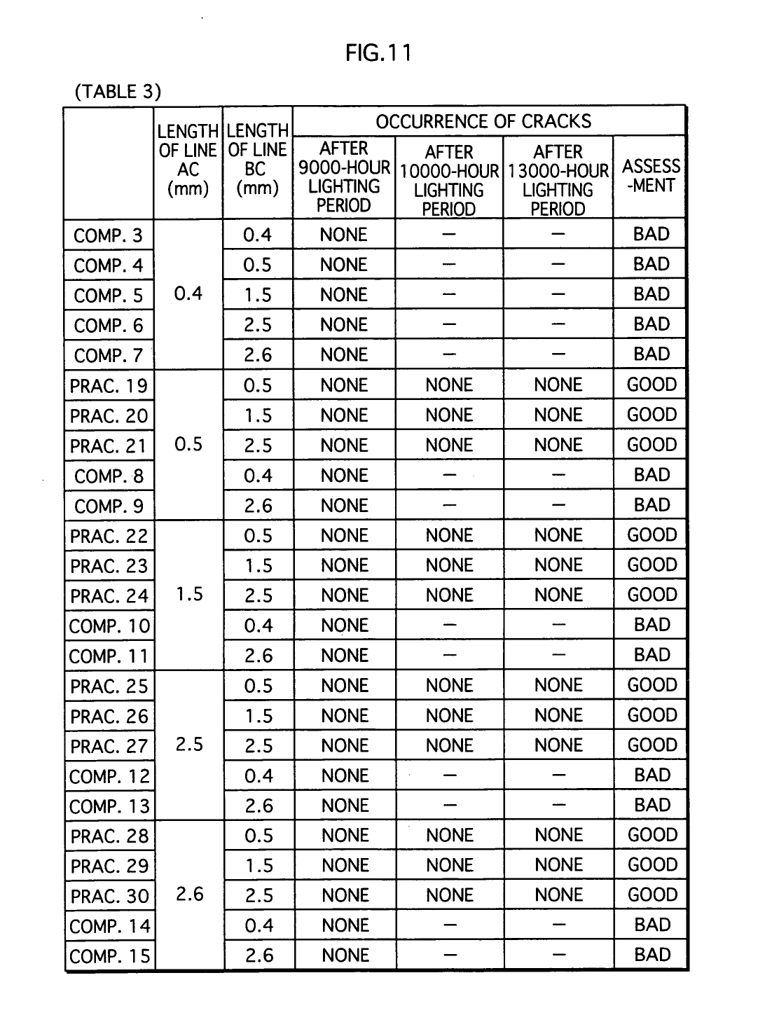

Then, a life test repeating cycles, each of which consists of a 5.5-hour-lighting phase and a 0.5-hour-light-off phase, was conducted with respect to each prepared lamp. Subsequently, occurrence of cracks within the thin tube 45, located close to the joining portion 41, was examined at lighting periods of 9000 hours, 10000 hours, and 13000 hours. The results of the examination are shown in Table 3 of FIG. 11.

Note that Practical Examples 19 to 30 and Comparative Examples 3 and 15 all have the same structure except for the lengths of the line AC and line BC. Each of the major components measures as follows: the outer diameter R1 of the central tube 40, 12.3 mm; the inner diameter r1 of the central tube 40, 11.0 mm; the outer diameter R2 of each thin tube 45, 3.0 mm; the inner diameter r2 of each thin tube 45, 1.0 mm; the maximum outer diameter R3 of the electrode inductors 24 and 25, 0.9 mm; the electrode projection length E1, 0.5 mm; and the minimum wall thickness t1, 1.0 mm. In addition, enclosed in the arc tube 3 as the light-emitting material are 12 wt % dysprosium iodide (DyI3), 12 wt % thulium iodide (TmI3), 12 wt % holmium iodide (HoI3), 16 wt % thallium iodide (TiI3), and 48 wt % sodium iodide (NaI), totaling 5.2 mg. Furthermore, 10 mg of mercury is also enclosed therein while argon gas being enclosed to be 13 kPa at 300 K.

In the columns of “OCCURRENCE OF CRACKS” in Table 3, “-” denotes that the arc tubes 39 of an example class caused a leak due to crack formation and thereby became unlit before a corresponding lighting period elapsed.

Each lamp was lit in a vertical position with the base 5 placed on the upper side. In this examination, all crack formation within the thin tube 45, located close to the joining portion 42, took place in the thin tube 45 at a lower position when the lamp was lit in the vertical position, as described hereinafter.

As is clear from Table 3, in any of Practical Examples 19 to 30, no cracks formed within the thin tube 45, located close to the joining portion 41, after a 13000-hour lighting period. On the other hand, although being free from crack formation within the thin tube 45, located close to the joining portion 41, after a 9000-hour lighting period, all of Comparative Examples 3 to 15 caused a leak and became unlit before a 10000-hour lighting period.

Then, each arc tube 39 of the following example classes was cut along a plane including the axis X in the longitudinal direction of the arc tube 39, and the inner surface was observed: Practical Examples 19 to 30 after a 13000-hour lighting period; and arc tubes 39 of Comparative Examples 3 to 15. The following was found through the observation.

Concerning all of Practical Examples 19 to 30 and Comparative Examples 3 to 15, a nearly equal sized gouge was found in an area, within the inner surface of the thin tube 45, located close to the joining portion 41. As to Comparative Examples 3 to 15, alumina gouged from the area was collectively deposited on the inner surface of the thin tube 45, located in the vicinity of the gouged area, on the side closer to the discharge space 23, and the deposit was in contact with the electrode inductor 24. Here, cracks formed, starting at the point of contact between the deposit and the electrode inductor 24.

However, as to Practical Examples 19 to 30, the gouged alumina was deposited only on the taper section 43, and no deposit was found on the inner surface of the thin tube 45. This is considered to be attributable to providing the taper section 43 on the inner surface of the boundary region 42 between the central tube 40 and the joining portion 41, and to setting the lengths of the line AC and line BC, respectively, in the range of 0.5 mm to 2.5 mm when a boundary point between the inner surface of the central tube 40 and the taper section 43 is the point A; a boundary point between the inner surface of the joining portion 41 and the taper section 43 is the point B; and an intersecting point of the straight line including the inner surface of the central tube 40 with a line extending perpendicularly from the point B towards this straight line is the point C. Herewith, temperature T₃ of the inner surface of the boundary region 42 between the central tube 40 and the joining portion 41, i.e. the taper section 43, became lower than temperature T₂ of the inner surface of the thin tube 45, located in the vicinity of the gouged area, on the side closer to the joining portion 41. Consequently, this facilitated the gouged alumina being precipitated on the taper section 43 with the temperature T₃, instead of on the inner surface part of the thin tube 45 with the temperature T₂. Note however that, regarding the metal halide lamp (rated lamp wattage: 150 W) of the second embodiment according to the present invention, the inner diameter r₁ of the central tube 40 has to be set at 5.5 mm or more, as in the case of the metal halide lamp 1 (rated lamp wattage: 150 W) of the first embodiment.

As in the case of the metal halide lamp 1 (rated lamp wattage: 150 W) of the first embodiment according to the present invention, even if rare earth halides are enclosed, the alumina generated as a result of part of the inner surface of the thin tube 45 being stripped can be precipitated and deposited-on the taper section 43 by: (1) setting the inner diameter r₁ of the central tube 40 at 5.5 mm or more; (2) providing the taper section 43 on the inner surface of the boundary region 42 between the central tube 40 and the joining portion 41; and (3) setting the lengths of the line AC and line BC, respectively, in the range of 0.5 mm to 2.5 mm when a boundary point between the inner surface of the central tube 40 and the taper section 43 is the point A; a boundary point between the inner surface of the joining portion 41 and the taper section 43 is a point B; and an intersecting point of the straight line including the inner surface of the central tube 40 with a line extending perpendicularly from the point B towards this straight line is the point C. Herewith, over a long lighting period, it is possible to prevent the deposit from coming in contact with components each having a different thermal expansion coefficient from the deposit, such as the electrode inductors 24 and 25, for example. As a result, the crack formation in the thin tube 45, especially in the vicinity of the joining portion 41, causing a leak can be prevented, and accordingly the operating life of the metal halide lamp can be extended.

As to the metal halide lamp (rated lamp wattage: 150 W) of the second embodiment also, it is desirable that an alkaline earth metal halide be enclosed in the envelope 44 in order to: (1) achieve further extension of the operating life by reducing the reaction between the alumina forming the envelope 44 and the rare earth halides and, herewith, slashing the amount of gouged alumina to be generated by the reaction with the rare earth metal halides; and (2) prevent the wall thickness of the envelope 44 from becoming thinner due to the reaction with the rare earth metal halides, which avoids a decrease in mechanical strength of the reacted area and reduces the likelihood of breakage of the envelope 44. It has been confirmed that the same effect can be obtained not only when calcium halide, such as calcium iodide or calcium bromide, is used as the alkaline earth metal halide, but also when magnesium halide or strontium halide is used. In particular, in the case when calcium halide is used as the alkaline earth metal halide, color rendering will be enhanced in addition to the effect described above.

Furthermore, it is desirable that the electrode projection length E₁ (mm) and the minimum wall thickness t₁ (mm) of the boundary region 42 between the joining portion 41 and the thin tube 45 be set to values found within an area defined by lines connecting four points of (E₁, t₁)=(0.5, 1.0), (0.5, 3.5), (5.0, 3.5) and (5.0, 0.5) in order to achieve further extension of the operating life by: preventing high stress due to the repetition of the lamp being lit on and off from being applied to the boundary region 42 between the joining portion 41 and the thin tube 45; and preventing crack formation in the boundary region 42 caused by the stress, which results in a leak.

### Third Embodiment

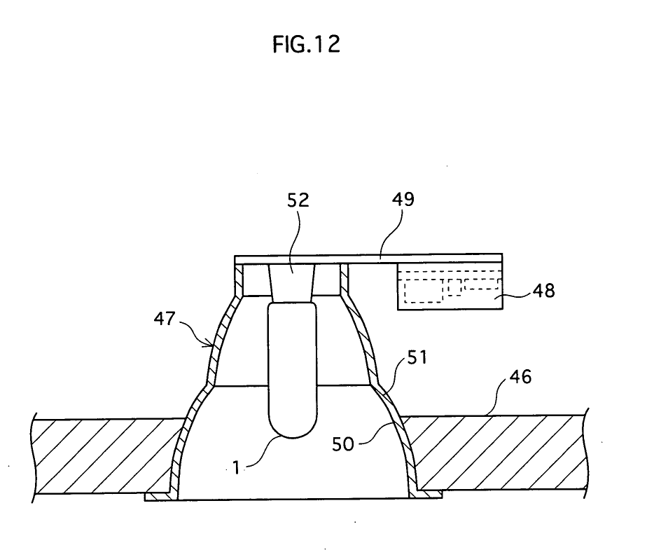

A luminaire according to a third embodiment of the present invention is, for example, a down light fixture set in a ceiling 46, as shown in FIG. 12, and comprises: a light fitting 47 buried in the ceiling 46; the metal halide lamp 1 (rated lamp wattage: 150 W) of the first embodiment, placed in the light fitting 47; and a lighting circuit 48 for lighting on the metal halide lamp 1.

The light fitting 47 and the lighting circuit 48 are fixed on a platy base unit 49.

The light fitting 47 includes: a lamp shade 51 having a reflection surface 50 internally; and a socket 52 which is disposed in the lamp shade 51 and to which the metal halide lamp 1 is attached.

As the lighting circuit 48, either a publicly known iron-core ballast or electronic ballast can be applied.

With the structure of the luminaire according to the third embodiment of the present invention, not only the cost of lamps but also the frequency of changing lamps can be reduced since the luminaire applies the longer-lasting metal halide lamp, which leads to a decrease in cost involved in replacing them.

Note that a metal halide lamp with a rated lamp wattage of 150 W is used in each of the above embodiments by way of example, however, the present invention can also be applied to a metal halide lamp with a rated lamp wattage of 70 W to 400 W, for example.

Additionally, the third embodiment is described by using the metal halide lamp 1 (rated lamp wattage: 150 W) of the first embodiment according to the present invention. However, the same effect can be achieved when the metal halide lamp 1 (rated lamp wattage: 150 W) of the second embodiment is used.

The third embodiment is described in the context of using the downlight light fitting 47 set in the ceiling 46, however, the same effect can also be achieved when various other publicly known light fittings are employed.

### Fourth Embodiment

As has been described, according to the above embodiments, when the shape of the envelope of the arc tube comprising the central tube and the joining portion is substantially rectangular in the cross section along a plane including the tube axis, the extension of the operating life can be achieved by setting the curvature radius R of the inner surface of the boundary region between the central tube and the joining portion in the range of 0.5 mm to 2.5 mm. On the other hand, a fourth embodiment describes a structure to achieve extension of the operating life of the arc tube by satisfying conditions other than the curvature radius R of the inner surface of the boundary region between the central tube and the joining portion when the curvature radius R exceeds 2.5 mm. [1] Structure of Arc Tube

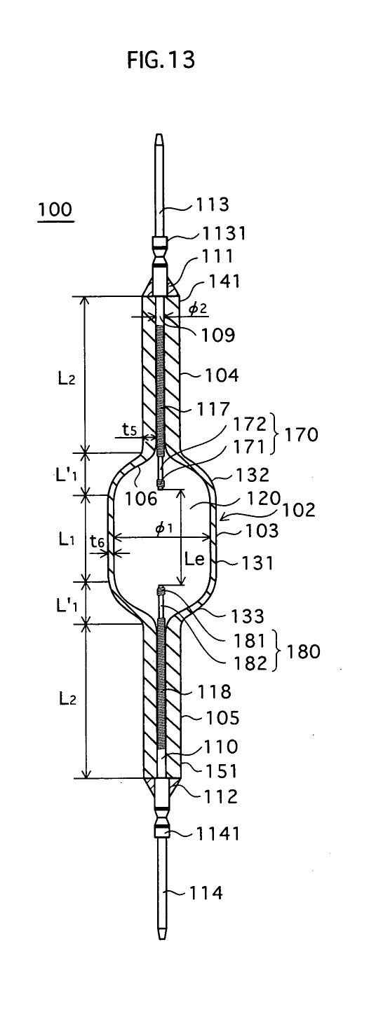

FIG. 13 is a cross-sectional view showing a structure of an arc tube 100 used in a metal halide lamp according to the fourth embodiment of the present invention.

In reference to the figure, the arc tube 100 has a rated lamp wattage of 150 W, and has an envelope structured with an integrally-formed translucent ceramic tube 102, which is made by integrally forming and sintering a main tube 103 in the middle and a pair of thin tubes 104 and 105 on each side of the main tube 103.

The main tube 103 further comprises a central tube 131 with an inner diameter φ₁ of 11.0 mm and round portions 132 and 133 (corresponding to the “joining portions” of the first and second embodiments) at the both ends. The overall length L₁ of the central tube 131 is 17.3 mm while the length L′₁ of each round portion 132/133 in the direction of the tube axis is 6.2 mm.

In order to enhance luminous efficiency by increasing especially light transmission, a wall thickness t₆ of the central tube 131 is set relatively small, in the range of 0.5 mm to 0.8 mm, according to a conventional 150-W lamp. For example, it is set to a typical thickness of 0.65 mm.

On the other hand, each of the thin tubes 104 and 105 has a tube inner diameter φ₂ of 1.0 mm and an overall length L₂ of 15.9 mm. In addition, a wall thickness t₅ is set within a predefined range based on considerations to be hereinafter described, and here it is set to a typical thickness of 1.1 mm.

Furthermore, in each inside corner 106 at the boundaries of the main tube 103 and thin tubes 104 and 105 (hereinafter, referred to simply as the “inside corner 106”), a rounded-off portion having a curvature radius in the range of 0.5 mm to 3.0 mm is formed. In the present embodiment, the curvature radius of the rounded-off portion is set to a typical size of 1.5 mm.

Inside the main tube 103 of the arc tube 100, a pair of tungsten (W) electrodes 170 and 180 (a length Le of the space between the electrodes: 10 mm) is positioned. Here, the electrodes 170 and 180 are respectively composed of: a tungsten electrode rod 172/182; and a tungsten electrode coil 171/181 mounted on the tip of the electrode rod 172/182.

Each electrode rod 172/182 is joined to an internal lead wire 109/110 (outer diameter: 0.9 mm) made from Al₂O₃—Mo conductive cermets at its one end located further from the discharge space 120, and is thereby held in place. A molybdenum (Mo) coil 117/118 is wound on part of electrode rod 172/182 placed into the thin tube 104/105 so as to prevent light-emitting material seepage.

The internal lead wire 109/110 is led out from an open end 141/151 of the thin tube 104/105 to the outside. At the same time, the open end 141/151 is airtightly sealed by Dy₂O₃—Al₂O₃—SiO₂ frits (sealing material) 111/112.

External lead wires 113 and 114 made from niobium are joined respectively to the ends of the internal lead wires 109 and 110, being led out from the thin tubes 104 and 105, and are thereby held in place on the same axis. Then, each of the joined parts is reinforced by setting a sleeve 1131/1141 in the joined part externally.

The frit 111/112 is filled close to a joined part of the internal lead wire 109/110 with the tungsten electrode rod 172/182 in order to prevent the internal lead wire 109/110 from corroding due to light-emitting material, especially while the lamp is lit.

A discharge space 120 is filled with light-emitting material composed of metal halides in which CaI₂ is mixed (to be described hereinafter), about 10 mg of mercury functioning as a buffer gas, and argon functioning as a starting gas to be approximately 13 kPa. [2] Composition of Light-Emitting Material

In an early phase of development, the present inventors experimentally produced a type of arc tube in which an integrally-formed ceramic tube was filled with a total of 5.2 mg of light-emitting material with the same composition ratio as a conventional 150-W lamp (i.e. 12% DyI₃+12% TmI₃+12% HoI₃+16% TiI+48% NaI).

This experimental arc tube has the same structure as the arc tube 100 in FIG. 13 except for the light-emitting material to be enclosed therein, and no rounded-off portions were provided in the inside corners 106 between the thin tubes and main tubes.

A metal halide lamp in which the experimental arc tube was set had an initial luminous flux of 13800 lm and a luminous efficiency of 92.0 lm/W. For reference's sake, a conventional 150-W lamp, in which the translucent ceramic tube has been made by assembling the components and subsequently sintering the assembled components, (hereinafter, referred as simply to an “assembled-and-sintered lamp”) had a luminous efficiency of 88.0 lm/W. Thus, the metal halide lamp having the experimental arc tube exhibited an approximately 4.5% improvement. This is mainly attributable to application of the integrally-formed translucent ceramic tube.

The metal halide lamp having the experimental arc tube also exhibited excellent lamp properties—an average color rendering index value (Ra) of 94 and a special color rendering index value (R9) of 40.

However, it became clear in an aging test that the thin tubes 104 and 105 of the experimental arc tube underwent breakage in a characteristic manner around when approximately 5000 hours had elapsed. In particular, thin tube breakage chiefly occurred in the lower thin tube of the experimental arc tube when the metal halide lamp was lit with the base placed on the upper side as well as the tube axis of the experimental arc tube coinciding with the vertical direction (hereinafter, referred to as “lit in a base-up position”).

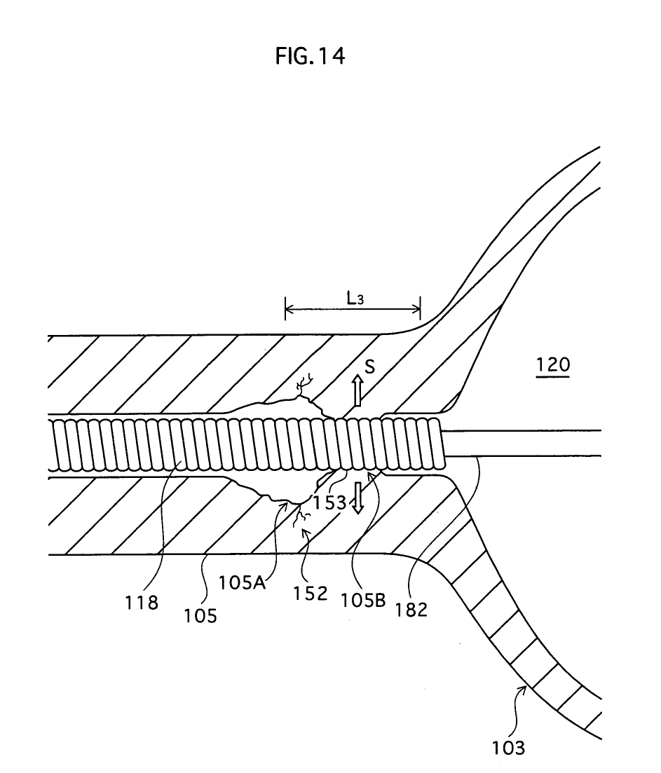

In order to investigate the cause, a cross section of the broken part in damaged experimental arc tubes was observed under a SEM (scanning electron microscope). A frame format in FIG. 14 shows a cross-sectional view obtained from the observation.

As shown in the figure, breakage of the thin tube 105 occurred at a part 105A, L₃ (i.e. approximately 5 to 6 mm) off from the edge of the main tube 103. In particular, the broken part 105A was concaved due to corrosion by light-emitting material. On the other hand, at a part 105B located in the vicinity of the broken part 105A, on the side closer to the main tube 103, Al₂O₃ deposit 153 in a convex shape had been newly formed, being in contact with the circumference of the Mo coil 118.

It is inferred that, when the metal halide lamp was lit in this state, stress S was generated in directions as shown by outlined arrows due to thermal expansion of the thin tube 105, molybdenum coil 118 and electrode rod 182 at the part 105B along with an increase in temperature. Then, the stress S exerted, as flexural stress, on the part 105A, which had been corroded and thereby had had a decrease in strength, and subsequently cracks 152 formed. This process was repeated, which resulted in the breakage of the thin tube 105.

Next, each component of the light-emitting material used in a conventional translucent ceramic metal halide lamp and its corroding effect on the translucent ceramic tube were examined in an experiment in order to study why the part 105A in the ceramic tube came under influence of corrosion.

In the experiment, quartz tubes, in each of which one component of the light-emitting material was enclosed together with a sample piece of the translucent ceramic tube and argon, were experimentally produced, and were treated with heat in a heating oven for 2000 hours at approximately 1100° C. Then, the degree of corrosion of each sample piece of the translucent ceramic tube was observed.

The observation revealed the corroding effect of each component included in the light-emitting material, and the corroding effect became smaller in the following order: TmI₃>HoI₃>DyI₃>>CeI₃≈PrI₃>TiI≈NaI≈CaI₂. Thus, it was found that particularly TmI₃, HoI₃ and DyI₃ of the rare earth metal halides have high corroding effects.

It was inferred that the rare earth metal halides transferred from the gas phase to the liquid phase at the part 105A in the thin tube 105, located slightly off from the edge of the main tube 103, and convection of the rare earth metal halides in the liquid phase occurred at this part 105A, which accelerated the corrosion in the thin tubes 105.

Accordingly, the inventors of the present application mixed, at a predetermined ratio, CaI₂ having a lower corroding effect with the conventional light-emitting material including the rare earth metal halides having significantly high corroding effects, i.e. TmI₃, HoI₃ and DyI₃, and the mixed result was enclosed in the arc tube 100. Herewith, the corrosion in the thin tube 105 and breakage due to the application of stress, which are characteristic to the experimental arc tube, were significantly reduced. This allowed the lamp to adequately achieve a rated life of 12000 hours, equivalent to that of the conventional 150-W assembled-and-sintered lamp. [3] Practical Example

The following gives a further detailed account on the structure of the arc tube 100 and characteristic features of a metal halide lamp 22 according to the present invention.

As to this practical example, a total of 7.2 mg of light-emitting material was enclosed in the arc tube 100 with a typical composition ratio of 7.7% DyI₃+7.6% TmI₃+7.6% HoI₃+11.3% TiI+37.2% NaI+28.6% CaI₂.

Other than this point, the current practical example has the same structure as the experimental arc tube. Herewith, the lamp 22 using the arc tube 100 achieved lamp properties including an initial luminous flux of 13500 lm, a luminous efficiency of 90 lm/W, an average color rendering index value (Ra) of 96 and a special color rendering index value (R9) of 75.

As compared to the experimental arc tube, the reason why the luminous efficiency decreased by approximately 2% is because CaI₂ was mixed with the light-emitting material of the present invention. Additionally, the reason why the R9 value increased from 40 to 75 is also because of CaI₂ mixing.

In an aging test, especially with the base-up position, the metal halide lamp of the fourth embodiment achieved an operating life of approximately 12000 hours (n.b. the operating life is defined as the aging time when the lumen maintenance has reached 70%), and no thin tube breakage was observed during the operating life.

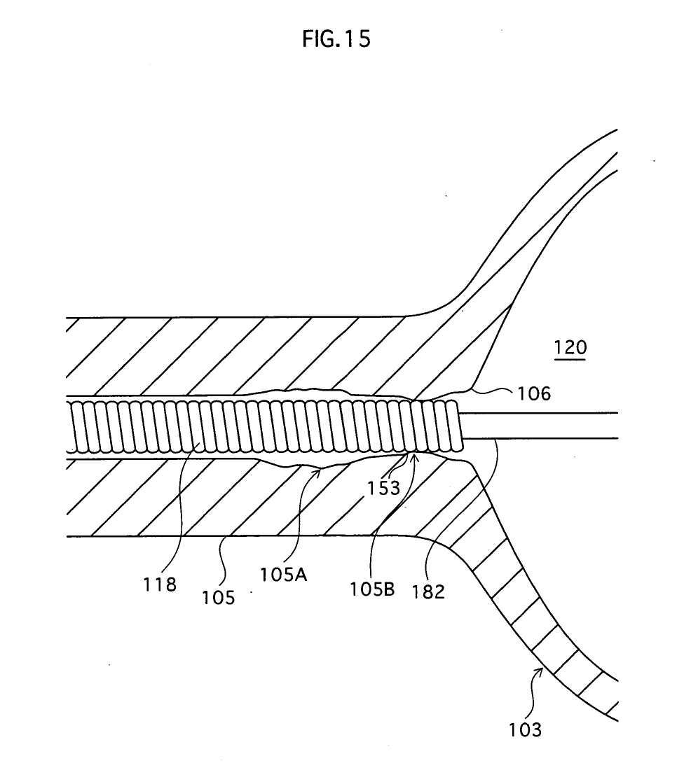

FIG. 15 is a frame format showing the observation results of the thin tube 105 at this point, obtained by scanning electron microscope.

As shown in the figure, the degree of corrosion at the part 105A was significantly reduced as compared to the case shown in FIG. 14. Along with the reduction of the corrosion, the amount of the Al₂O₃ deposit 153 was also decreased. Accordingly, the likelihood of the thin tube breakage became markedly lower than the case of FIG. 14, and thereby the lamp operating life was dramatically extended.

The effect of reducing the corrosion in the thin tube 105 according to the above structure is attributable to the fact that TmI₃, HoI₃ and DyI₃, which are the rare earth metal halides having high corroding effects, are diluted by mixing CaI2 accounting for a relatively high composition ratio in the light-emitting material. Thereby, the chance of these rare earth metal halides coming into contact with the part 105A in the thin tube 105 is effectively reduced. [4] Ideal Ranges of Amount of CaI₂ to be Mixed and Wall Thickness of Thin Tube

It was demonstrated that the corrosion in the thin tube 105 was largely reduced by mixing CaI₂ in the light-emitting material as described above.

Here, the advantages of mixing CaI₂ above are that the corroding effect on the translucent ceramic tube is low as stated above and that negative effects on the lamp properties can be reduced to a lower level even if the composition ratio is comparatively increased.

Nonetheless, it is undeniable that the luminous efficiency of CaI₂ is rather less compared to the rare earth metal halides, such as TmI₃, HoI₃ and DyI₃. For example, the arc tube 100 of the above practical example, in which a rare earth metal halide of CaI₂ was mixed in the light-emitting material, accounting for 28.6 mole %, showed a 2% decrease in the luminous efficiency, as compared with the case where no CaI₂ was mixed in.

Accordingly, in order to achieve a high luminous efficiency, which is one of the present invention's objectives, it is necessary to set an upper limit on the amount of CaI₂ to be mixed.

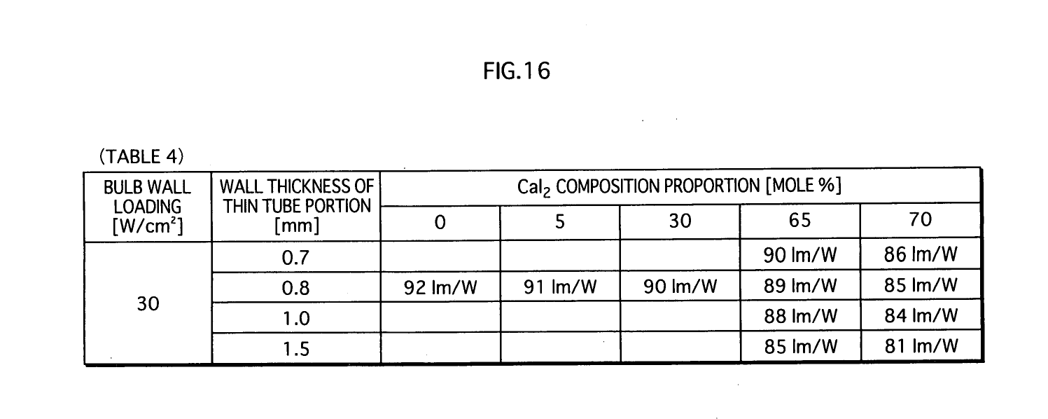

Regarding a metal halide lamp using a test arc tube with a bulb wall loading of 30 W/cm², the luminous efficiency (lm/W) was measured by changing the mole % of CaI₂ while maintaining the same components of the light-emitting material as above. Table 4 in FIG. 16 shows the experimental results.

As can be seen from the table, the luminous efficiency gradually decreased as the mole % of CaI₂ increased, and the luminous efficiency plunged with a CaI₂ ratio of more than 65 mole %, falling to below about 88 lm/W, which is the luminous efficiency of a 150-W metal halide lamp using a conventional assembled-and-sintered arc tube. Thus, if the CaI₂ ratio exceeds 65 mole %, it is impossible to achieve the objective of the present invention—enhancing the luminous efficiency to be larger than that of the metal halide lamp using the assembled-and-sintered arc tube. Nearly the same results were obtained for metal halide lamps each having a different bulb wall loading, and it can be said that the upper limit of CaI₂ to be mixed should desirably be set no more than 65 mole % according to the above considerations.

Contrarily, if the amount of CaI₂ mixed is too small, the corrosion in the thin tube may not be sufficiently reduced, which may subsequently lead to providing only insufficient prevention against breakage of the thin tube.

On the other hand, even if a sufficient amount of CaI₂ is mixed, the corrosion in the thin tube is not entirely eliminated, and therefore it would be desirable that the wall thickness of the thin tube be set no less than a certain thickness. However, setting the wall thickness too large is not desirable since this causes a decrease in the luminous efficiency.

That is, in order to achieve sufficient lamp's operating life while ensuring a desired high luminous efficiency, it is desirable that the amount of CaI₂ to be mixed and the wall thickness of the thin tube be respectively set in ideal ranges.

Accordingly, the inventors of the present application prepared a plurality of test lamps having different combinations of the composition ratio Mca (mole %) of CaI₂ to the sum total of all the metal halides and wall thickness t₅ (mm) of the thin tube. Then, a lamp aging test was conducted by setting the bulb wall loading of each test lamp to one of 20 W/cm², 30 W/cm² and 40 W/cm², all of which are within the range of a regular lamp, and occurrence of cracks in the thin tube was examined. All other conditions of the test lamps were the same as those of the present embodiment above.

In the aging test, the light-emitting material enclosed in the arc tube included DyI₃, TmI₃, HoI₃, TiI and NaI, while the composition ratio of CaI₂ was changed between 0 mole % and the upper limit of 65 mole % as described above.

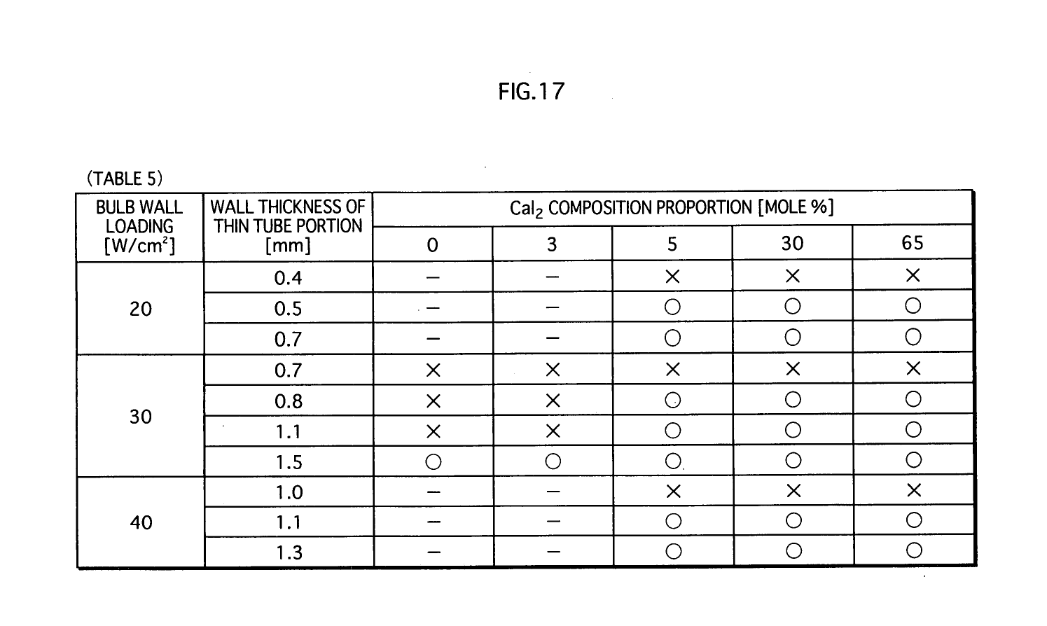

Table 5 in FIG. 17 shows the results of the above aging test.

In the table, “o” denotes that no cracks formed in the thin tube after 9000 hours in the aging test while “x” denotes that cracks formed before 9000 hours.

The first thing noticed in the table is that, even if 65 mole % CaI₂ was enclosed, cracks formed when the wall thickness of the thin tube was smaller than a certain value.

In addition, it is learned that the minimum wall thickness of the thin tube not to form cracks changes according to the bulb wall loading, and that the thin tube needs to have a wall thickness of at least 0.5 mm, 0.8 mm and 1.1 mm when the bulb wall loading was 20 W/cm², W/cm² and 40 W/cm², respectively.

If the wall thickness of the thin tube is set too large, the luminous efficiency decreases. As can be seen from the test results in Table 4 above, in the case where the bulb wall loading was 30 W/cm², the luminous efficiency largely decreased if the wall thickness of the thin tube was 1.5 mm. As a result, it is desirable that the wall thickness of the thin tube be no more than 1.5 mm.

The inventors of the present application have confirmed that the upper limit of the wall thickness is not influenced by the bulb wall loading since it is related to the rate of the decrease in luminous efficiency, and that it is desirable that the wall thickness be less than 1.5 mm also when the bulb wall loading is other than 30 W/cm².

As stated, it is desirable that, regardless of the bulb wall loading, the upper limit of the wall thickness of the thin tube be less than 1.5 mm without exception, however, the lower limit of the wall thickness is dependent on the bulb wall loading.

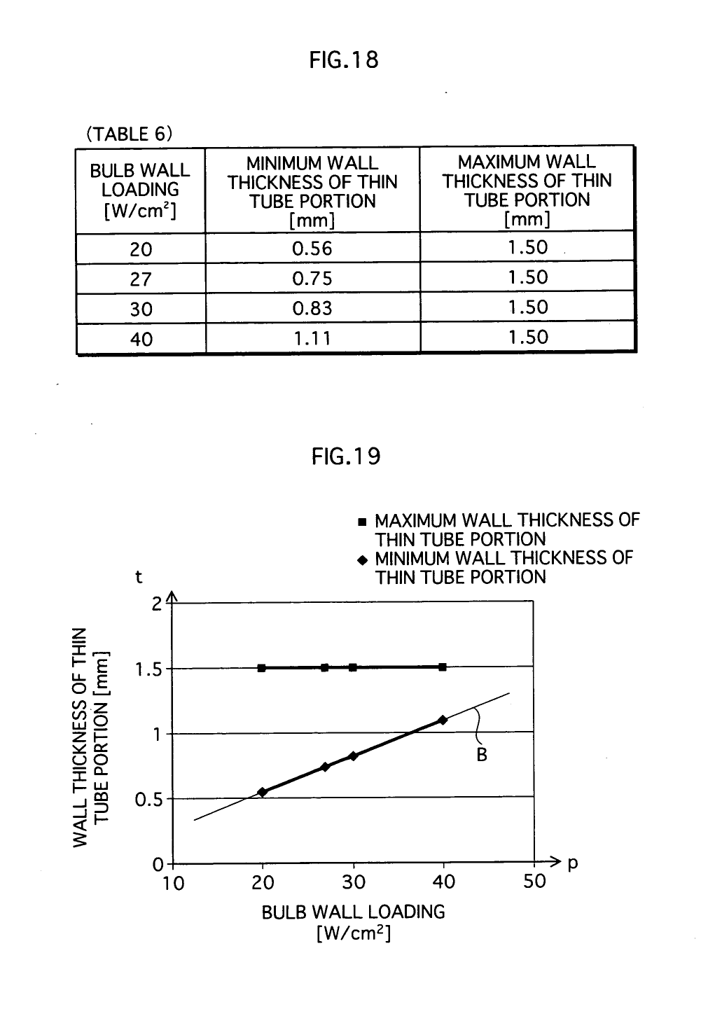

Accordingly, in order to further clarify the relationship between the lower limit of the wall thickness of the thin tube and the bulb wall loading, the lower limit of the wall thickness with two decimal places where no cracks formed within the thin tube was found for each case when the bulb wall loading was 20 W/cm², 27 W/cm², 30 W/cm² and 40 W/cm², respectively, while 5 mole % CaI₂ being mixed in the light-emitting material. Table 6 of FIG. 18 shows the experimental results.

FIG. 19 is a graph where the values shown in Table 6 are plotted.

In the graph, the horizontal axis p indicates the bulb wall loading (W/cm²) while the vertical axis t indicating the wall thickness (mm) of the thin tube. As shown in the graph, it was found that the lower limits of the wall thickness aligned approximately on a straight line B. The straight line B was found based on the plotted values, being approximated as t=p/36.

Hence, it is desirable to satisfy p/36≦t₅<1.5, where t₅ is the wall thickness of the thin tube in mm and p is the bulb wall loading in W/cm².

Note that this inequality condition came from the experimental results obtained when CaI₂ accounted for 5 mole % of the light-emitting material. If more than 5 mole % CaI₂ is included, the thin tube will be less susceptible to corrosion, and accordingly, no cracks will form if the wall thickness of the thin tube is at least p/36 for CaI₂ in the entire range of 5 mole % to 65 mole %.

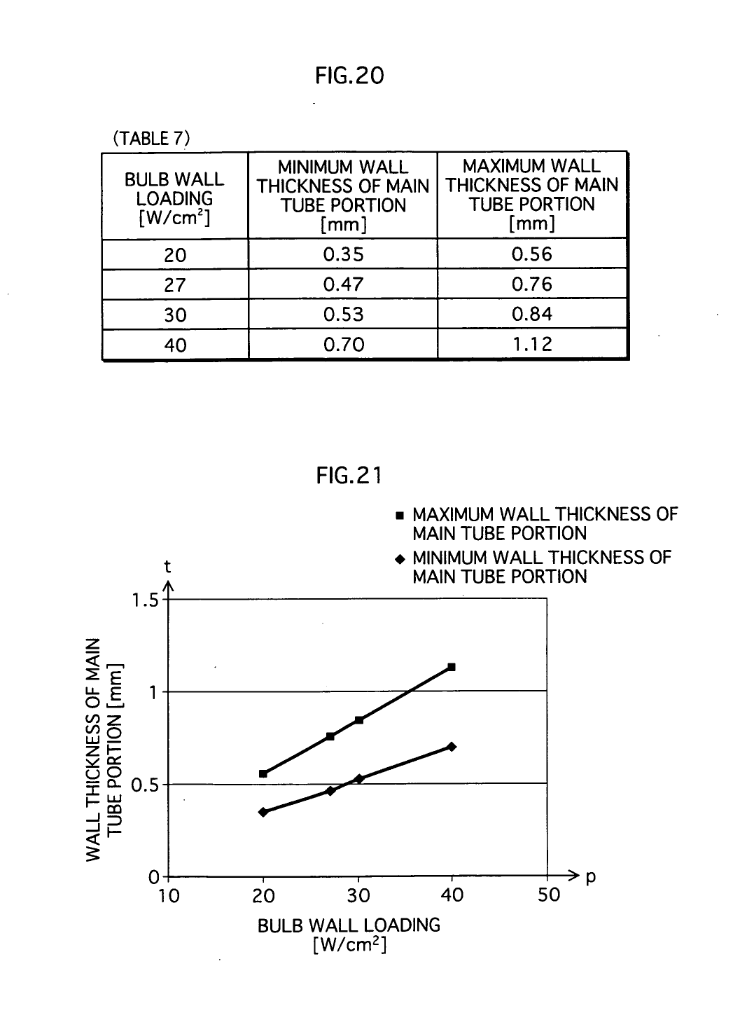

For reference's sake, an experiment was conducted on the range of the wall thickness of the main tube, and the results shown in Table 7 of FIG. 20, regarding the upper and lower limits, were obtained.

By considering the possible decrease in the luminous efficiency due to increasing the wall thickness of the main tube, each of the upper limits was determined so as to achieve a luminous efficiency of 88 lm/W or more with CaI₂ accounting for 5 mole % of the light-emitting material. On the other hand, the lower limits were the minimum wall thicknesses free from crack formation after a 9000-hour lighting period in the lamp aging test.

FIG. 21 is a graph on which the results are plotted.

In consequence, a metal halide lamp having the highest luminous efficiency, preventing thin tube breakage, and achieving a satisfying lamp operating life can be attained by, for example when the bulb wall loading is 30 W/cm², setting the wall thickness of the thin tube, the wall thickness of the main tube, and the CaI₂ composition ratio to their minimums, i.e. 0.83 mm, 0.53 mm, and 5 mole %, respectively. [5] Formation of Rounded-Off Portions in Inside Corners at Boundaries of Thin Tubes and Main Tube

It has also become clear that, mixing CaI₂ in the light-emitting material results in, besides the prevention of the corrosion in the thin tube, a phenomenon in which the part 105B with the alumina deposition forms at a position slightly closer to the discharge space 20, as shown in FIG. 15, when compared to the case in FIG. 14.

It is inferred that the precipitation temperature was altered as a result that Al₂O₃ having liquated out due to corrosion formed a compound with Ca, and herewith the deposition position was shifted.

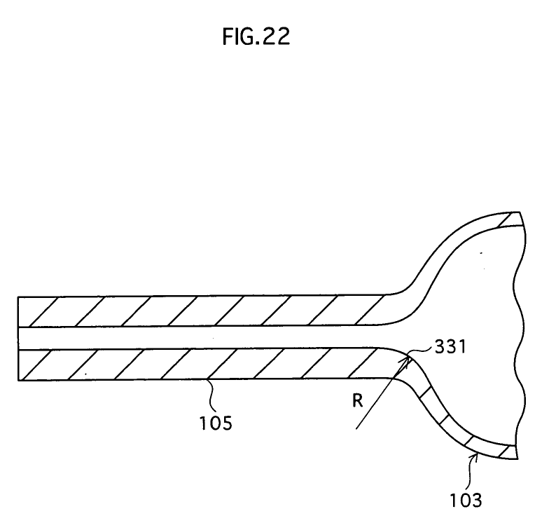

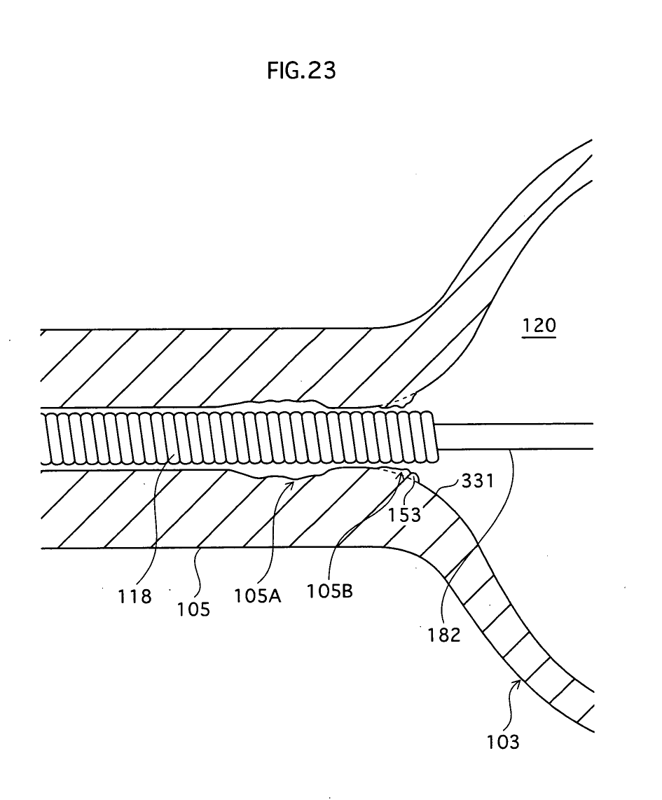

Accordingly, the inventors of the present application provided a rounded-off portion 331 having a curvature radius of 1.5 mm in each of the inside corners 106 (FIG. 15) at the boundaries of the thin tubes and the main tube, as shown in FIG. 22, and conducted an evaluation experiment similar to the above experiment. According to the observation, as shown in FIG. 23, it was confirmed that the Al₂O₃ deposit 153 was formed at the rounded-off portion 331 while the molybdenum coil 118 became entirely free from contact with the deposit 153, and that the lamp operating life was further extended.

In addition, what was made clear is that it is appropriate to set the curvature radius of the rounded-off portion 331 in the inside corners of the arc tube 100 within the range of 0.5 mm to 3.0 mm.

This is because, if the curvature radius of the rounded-off portion 331 is less than 0.5 mm, it is sometimes the case that the Al₂O₃ deposit 153 comes in contact with the molybdenum coil 118 after an aging period of approximately 8000 hours. On the other hand, if the curvature radius is more than 3.0 mm, the clearance gap between the thin tube 105 and the molybdenum coil 118 becomes too large, which leads to an increase of light-emitting material deposited in the clearance gap. As a result, the luminous flux during the life decreases by as much as approximately 5% as compared to that of the conventional arc tube, which is undesirable. [6] Summary

In conclusion, in the case where rare earth metal halides, such as TmI₃, HoI₃ and DyI₃, are used as light-emitting material, it is desirable for an indoor metal halide lamp having an arc tube that uses an integrally-formed translucent ceramic tube to satisfy the following conditions, in order to achieve higher luminous efficiency as well as to maintain a better operating life compared to an arc tube having a conventional assembled-and-sintered ceramic tube.

(i) CaI₂ in the range of 5 mole % to 65 mole % of the entire light-emitting material is mixed; and

(ii) t₅ is set so as to satisfy p/36≦t₅<1.5, where t₅ is the wall thickness of the thin tube in mm and p is a bulb wall loading in W/cm².

(iii) Further desirably, a rounded-off portion having a curvature radius in the range of 0.5 mm to 3.0 mm is provided in each of the inside corners between the thin tubes and the main tube.

### Fifth Embodiment

An arc tube according to a fifth embodiment is characterized by further enclosing CeI₃ (cerium iodide) in addition to the light-emitting material of the fourth embodiment above.

Here, a total of 7.5 mg of light-emitting material was enclosed in an arc tube with a typical composition of 7.5% DyI₃+7.5% TmI₃+7.4% HoI₃+11.1% TiI+36.3% NaI+27.8% CaI₂+2.4% CeI₃.

Thus further CeI₃ was mixed, in addition to CaI₂ of the fourth embodiment, because the decrease in luminous efficiency due to mixing CaI₂ can be compensated by adding CeI₃ which emits the green range of the spectrum having high relative luminous efficiency in an efficient fashion.

Other than this point, the arc tube of the fifth embodiment has the same structure as the arc tube 100 of the fourth embodiment.

In fact, a metal halide lamp using the arc tube of the fifth embodiment achieved an initial luminous flux of 14700 lm and a luminous efficiency of 98 lm/W, which is approximately 6% higher than that of the metal halide lamp of the fourth embodiment.

In addition, the metal halide lamp also maintained the lamp color rendering at a comparatively excellent level—an average color rendering index value (Ra) of 95 and a special color rendering index value (R9) of 70.

Additionally, the metal halide lamp of the present embodiment achieved an operating life of about 12000 hours or more, which is equivalent to that of the metal halide lamp of the fourth embodiment, and during the operating life, characteristic breakage in the thin tube was not observed. The degree of corrosion, especially in the thin tube 105 of the translucent ceramic tube 102 was remarkably lowered. The Al₂O₃ deposit 153 was observed at the rounded-off portion 331 in the inside corner 106 formed at the boundary of the main tube 103 and the thin tube 105 in the translucent ceramic tube 102.

The advantage of the CeI₃ addition pertaining to the fifth embodiment is to possibly reduce negative effects on the lamp's operating life because CeI₃ exhibits a low degree of corrosion to the translucent ceramic tube, as has been described, and achieves high luminous efficiency with a comparatively small composition ratio.

As a result of a detailed examination on the CeI₃ addition, it has been made clear that setting the composition ratio Mce (mole %) of CeI₃ in the range of 0.5 to 10 mole % of the sum total of all the metal halides above is appropriate.

If the composition ratio is smaller than 0.5 mole %, a significant increase in the luminous efficiency of as much as about 4% or more cannot be achieved. On the other hand, if the composition ratio is larger than 10 mole %, the lamp's emission color shifts to the greenish range with a deviation Duv of approximately 5 or more off from the so-called-Planckian locus on the chromaticity diagram, and becomes unsuitable for store lighting.

Thus, according to the fourth and fifth embodiments, it is possible to realize a long operating life, provide excellent cost performance, and achieve high color rendering. Therefore, when luminaries having such metal halide lamps (see FIG. 12) are set up, especially in shops, the colors of goods appear vibrant, which leads to largely attracting the customer's attention.

Note that the metal halide lamps having arc tubes of the fourth and fifth embodiments are capable of further achieving the following advantages compared to those of the first and second embodiments.

Regarding the metal halide lamps according to the fourth and fifth embodiments, each of the boundary regions, on the inner surface, between the joining portions and the central tube has a larger curvature radius R. As a result, the difference in distance between the emission center (i.e. the middle point of the space between the electrodes) and the entire inner wall surface facing the discharge space can be made small, as compared to the metal halide lamps of the first and second embodiments. Herewith, the temperature difference in the inner wall surface facing the discharge space while the lamp is lit can be made small, which in turn provides advantages of enabling the halogen cycle to work evenly in the light emitting part and thereby causing no partial blackening therein. Accordingly, it is considered that the lumen maintenance of each of the metal halide lamps according to the fourth and fifth embodiments after a long lighting period will be increased, as compared to the first and second embodiments.

Additional Particulars

(1) The effect of mixing CaI₂ for preventing the thin tube breakage in the fourth and fifth embodiments was also confirmed with a lamp containing light-emitting material including at least one of TmI₃, HoI₃ and DyI₃, which are rare earth metal halides having especially high corroding effects.

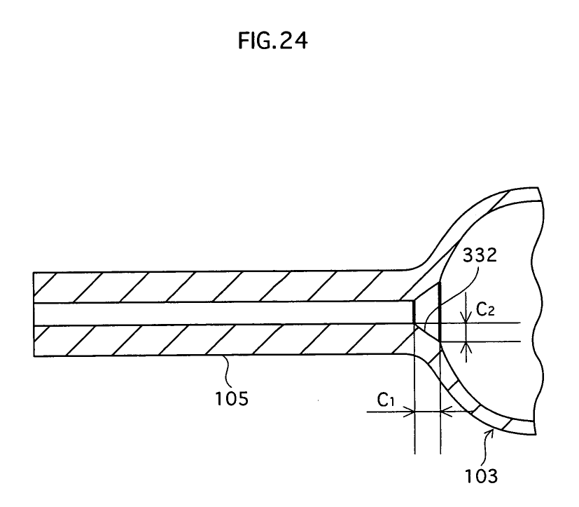

(2) In the fourth and fifth embodiments, the operating life is extended by forming the rounded-off portion having a predetermined curvature radius R in each inside corner of the arc tube. However, the same effect can be achieved by chamfering the inside corners, as shown in FIG. 24.

When the dimension of a chamfer 332 in the direction parallel to the tubular axis is C1 while the dimension of a chamfer 332 in the direction perpendicular to the tube axis is C2, it is desirable that both C1 and C2 be respectively in the range of 0.5 to 3.0 mm, for a similar reason why the range of the curvature radius R of the rounded-off portion is defined as is.

(3) In the fifth embodiment above, CeI₃ is added to the light-emitting material in order to improve the luminous efficiency, however either part of, or the entire CeI₃ may be replaced with PrI₃. Since PrI₃ has the same characteristic trait as CeI₃, the luminous efficiency can be improved without any adverse effect on the lamp's operating life.

In this case also, it is desirable that the mole % of PrI₃ (the mole % of CeI₃ and PrI₃ added together, in the case when CeI₃ is also added along with PrI₃) be set in the same range as in the case of CeI₃ of the fifth embodiment, i.e. 0.5 to 10 mole %.

(4) The results of the experiment described in each of the embodiments above were obtained from when polycrystalline alumina was used as a material of the translucent ceramic arc tube. However, since yttrium aluminum garnet (YAG) and aluminum nitride or the like, each of which is known as a translucent ceramic usable as a material of the arc tube, is also susceptible to corrosion, the same effects described above can be achieved by providing the same structure as the respective embodiments in the case when the arc tube is made from such a translucent ceramic.

(5) In each of the embodiments above, metal iodides are cited as examples of the metal halides, however, the same effect can be achieve by using metal compounds with halides other than iodine (I), such as bromine (Br) or chlorine (Cl).

(6) In the fifth embodiment, it is desirable that the total amount of the rare earth metal halides including Ce and Pr be in the range of 2 mole % to 40 mole % of the sum total of the halides enclosed in the arc tube. It has been confirmed in an experiment that desired color property and luminous efficiency cannot be obtained if the composition ratio is less than 2 mole %. On the other hand, if it is more than 40 mole %, the degree of corrosion becomes extremely high, and as a result, cracks form within the thin tube in a short time.

(7) Although, a comparatively compact indoor metal halide lamp is described in each of the embodiments above, the present invention is also applicable to an outdoor metal halide lamp of large size. Even if the metal halide lamp is large, the application of the present invention may be necessary because there is a still chance, if any, that the thin tube breaks due to corrosion if the bulb wall loading is increased in order to enhance the luminance.

(8) Although, a metal halide lamp having a rated lamp wattage of 150 W is described in the fourth and fifth embodiments above, the present invention is not limited to this and is applicable to metal halide lamps having a rated lamp wattage in the range of as low as 10 W to as high as 400 W.

(9) The envelope of the arc tube described in each of the above embodiments has been integrally formed altogether. However, as long as the thin tubes and main tube of the envelope have been integrally formed, the present invention regards the envelope as being integrally formed, even if the central tube of the main tube was originally separate in two sections along the direction of the tube axis and these two sections have been assembled to form the central tube by shrink-fit process.

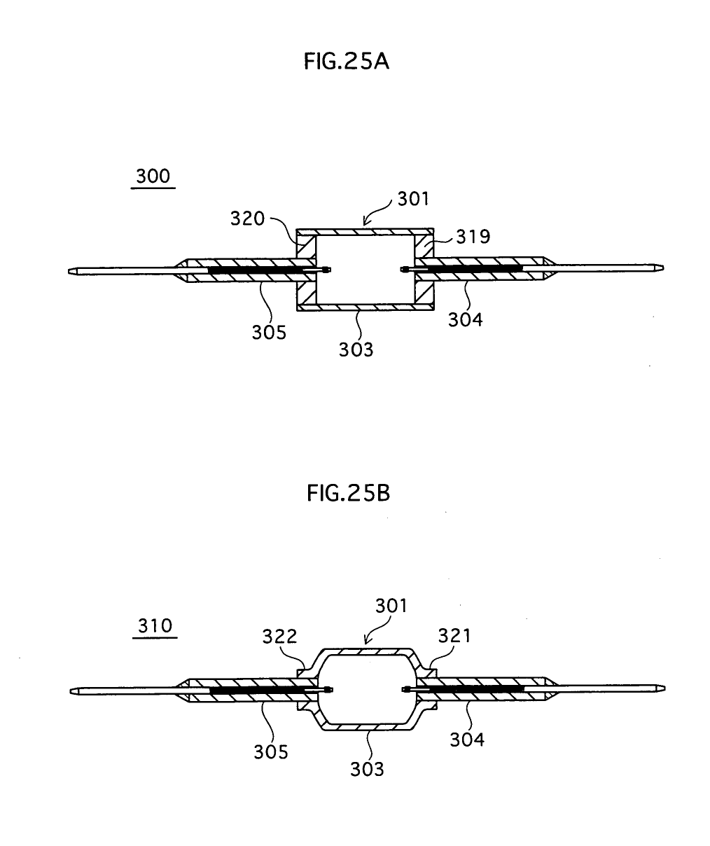

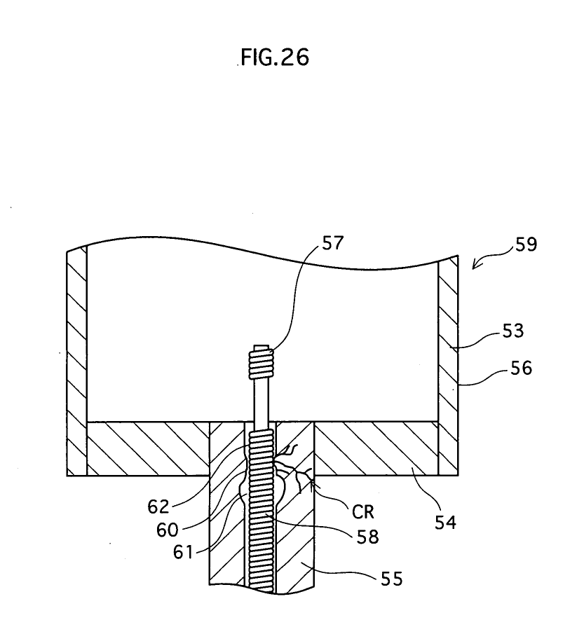

Instead, an arc tube 300 shown in FIG. 25A may be used. A main tube 301 of the arc tube 300 is formed by closing up the both open ends of a cylindrical tube 303 with a pair of disc-shaped blocking plates 319 and 320, and then each thin tube 304/305 is inserted into a through-hole in the central part of the blocking plate 319/320 of the main-tube 301. The result is integrally sintered and joined to form the arc tube 300. Alternatively, an arc tube 310 shown in FIG. 25B may be used. As an envelope of the arc tube 310, a translucent ceramic tube may be adopted which is formed by: first, providing small diameter portions 321 and 322 at both ends of the cylindrical tube 303 to form the main tube 301; then, joining the thin tubes 304 and 305 directly with the small diameter portions 321 and 322; and subsequently, sintering and integrating the result into one piece.

Each of the envelopes shown in FIGS. 25A and 25B is generally referred to as an “assembled-and-sintered ceramic tube” since the main tube 301 and the thin tubes 304 and 305 are, first, created individually, then assembled into one piece, and subsequently sintered. In such an assembled-and-sintered ceramic tube, the wall thickness of the joining portions between the main tube 301 and the thin tubes 304 and 305 (i.e. 319 and 320 in FIG. 25A; 321 and 322 in FIG. 25B) needs to be large because of the possibility of crack formation while the ceramic tube is integrally sintered. Accordingly, the heat capacity of these joining portions may increase and the quantity of heat conduction loss may subsequently increase while the light transmission of the joining portions decreasing, which in turn may lead to a decrease in the ratio of the total lumen flux of the lamp to the lamp voltage (i.e. luminous efficiency). Viewed in this light, an arc tube having an integrally-formed envelope, as shown in each of the above embodiments, is expected to achieve a higher luminous efficiency.

### INDUSTRIAL APPLICABILITY

The metal halide lamp of the present invention is suitable as a long-lasting light source since it is capable of preventing crack formation, especially in the thin tubes, located close to the joining portions, and the subsequent leak over a long lighting period.

1. A metal halide lamp comprising an arc tube that includes:
a translucent ceramic envelop having a central tube having an inner diameter of 5.5 mm or more and two thin tubes respectively connected to each end of the central tube via joining portions, and enclosing therein at least a rare earth halide; and
electrode inductors, each of which (1) has an electrode formed at a tip end thereof, (2) is inserted into one of the thin tubes with a clearance gap provided between the electrode inductor and the thin tube so that the electrode is disposed in a space surrounded by the central tube and the joining portions, and (3) is sealed in the thin tube at an end thereof opposite a central tube side, wherein
in a cross section of the envelope along a plane including an axis in a longitudinal direction of the arc tube, an angle α formed by each straight-line section of an inner surface of the central tube and a straight-line section of an inner surface of a respective one of the joining portions is in a range of 85° to 115°, and
a curvature radius of an inner surface of each boundary region between the central tube and the joining portions is in a range of 0.5 mm to 2.5 mm.

2. A metal halide lamp comprising an arc tube that includes:
a translucent ceramic envelop including a central tube having an inner diameter of 5.5 mm or more and two thin tubes respectively positioned on each end of the central tube via joining portions, and enclosing therein at least a rare earth halide; and
electrode inductors, each of which (1) has an electrode formed at a tip end thereof, (2) is inserted into one of the thin tubes with a (clearance) gap provided between the electrode inductor and the thin tube so that the electrode is disposed in a space surrounded by the central tube and the joining portions, and (3) is sealed in the thin tube at an end thereof opposite a central tube side, wherein
in a cross section of the envelope along a plane including an axis in a longitudinal direction of the arc tube, an angle α formed by each straight-line section of an inner surface of the central tube and a straight-line section of an inner surface of a respective one of the joining portions is in a range of 85° to 115°, and
a taper section is formed on an inner surface of each boundary region between the central tube and the joining portions, and in the cross section, a length of line segment AC and a length of line segment BC are respectively in a range of 0.5 mm to 2.5 mm when a boundary point between the inner surface of the central tube and the taper section is a point A, a boundary point between the inner surface of the respective one of the joining portions and the taper section is a point B, and an intersecting point of a straight line extending from the straight-line section of the inner surface of the central tube with a line extending perpendicularly from the point B toward the straight line is a point C.

3. The metal halide lamp of claim 1, wherein
an alkaline earth metal halide is enclosed in the envelope.

4. The metal halide lamp of claim 1, wherein
when a projection length of the electrode is E (mm) and a minimum wall thickness of each boundary region between the joining portions and the thin tubes is tb (mm), each value for the projection length E and the minimum wall thickness tb is found within an area defined by lines connecting four points of (E, tb)=(0.5, 1.0), (0.5, 3.5), (5.0, 3.5), and (5.0, 0.5).

5. The metal halide lamp of claim 1, wherein
the envelope is fabricated by integrally forming the central tube, the joining portions, and the thin tubes.

6. A metal halide lamp comprising an arc tube including an envelope which is a translucent ceramic tube having a main tube in a center thereof and a pair of thin tubes on each side of the main tube, a light emitting material being enclosed in the envelope, wherein
the light emitting material contains at least one rare earth metal halide selected from the group consisting of thulium (Tm), holmium (Ho) and dysprosium (Dy) along with a calcium halide having a composition ratio in a range of 5 mole % to 65 mole % to all metal halides enclosed in the envelope, and
p/36≦tn<1.5 is satisfied, where tn is a wall thickness (mm) of each thin tube and p is a bulb wall loading (W/cm2) at time when the metal halide lamp is lit.

7. The metal halide lamp of claim 6, wherein
a rounded-off portion having a curvature radius in a range of 0.5 mm to 3.0 mm is formed at a corner of each boundary between the main tube and the thin tubes, facing a discharge space.

8. The metal halide lamp of claim 6, wherein
a corner of each boundary between the main tube and the thin tubes, facing a discharge space, is processed to form a chamfer having respective dimensions in a direction parallel to an axis of the envelope and in a direction perpendicular to the axis in a range of 0.5 mm to 3.0 mm.

9. The metal halide lamp of claim 6, wherein
the light emitting material further contains at least one metal halide selected from the group consisting of cerium halides and praseodymium halides, having a composition ratio in a range of 0.5 mole % to 10 mole % to all metal halides enclosed in the envelope.

10. The metal halide lamp of claim 6, wherein
the envelope is fabricated by integrally forming the main tube and the thin tubes.

11. A luminaire comprising:
a metal halide lamp recited in claim 1;
a light fitting housing the metal halide lamp; and
a lighting circuit for lighting the metal halide lamp.

12. A luminaire comprising:
a metal halide lamp recited in claim 2;
a light fitting housing the metal halide lamp; and
a lighting circuit for lighting the metal halide lamp.

13. A luminaire comprising:
a metal halide lamp recited in claim 6;
a light fitting housing the metal halide lamp; and
a lighting circuit for lighting the metal halide lamp.

14. The metal halide lamp of claim 2, wherein
an alkaline earth metal halide is enclosed in the envelope.

15. The metal halide lamp of claim 2, wherein
when a projection length of the electrode is E (mm) and a minimum wall thickness of each boundary region between the joining portions and the thin tubes is t_{b} (mm), each value for the projection length E and the minimum wall thickness t_{b} is found within an area defined by lines connecting four points of (E, t_{b})=(0.5, 1.0), (0.5, 3.5), (5.0, 3.5), and (5.0, 0.5).

16. The metal halide lamp of claim 2, wherein
the envelope is fabricated by integrally forming the central tube, the joining portions, and the thin tubes.
